(19) United States
(12) Patent Application Publication
(10) Pub. No.: US 2025/0173724 A1
(43) Pub. Date: May 29, 2025

(54) AI Neural Consensus Networks Integrated With Distributed Ledger Technology

(71) Applicant: Scott Silver, Homestead, FL (US)

(72) Inventor: Scott Silver, Homestead, FL (US)

(21) Appl. No.: 18/519,540

(22) Filed: Nov. 27, 2023

(51) Int. Cl. G06Q 20/40; G06Q 20/38

(52) U.S. Cl. CPC G06Q 20/4016; G06Q 20/389

(57) ABSTRACT

AI neural networks are integrated with distributed ledger technology (DLT), including the integration of decentralized oracles, to enhance the functionality, security, and efficiency of systems. The integration incorporates several components and methods comprising novel neural network architectures, data preprocessing techniques, DLT integration approaches, privacy and security measures, consensus mechanisms, and others. The invention enables the development of neural smart contracts, neural consensus algorithms, dynamic neural network training, neural network optimization techniques, hybrid DLT architectures, neural network interpretability methods, and reinforcement learning for neural smart contract execution. By integrating decentralized oracles into the system, the invention has the capability to further enhance the reliability, accuracy, and diversity of data used within the DLT, improving transaction validation, consensus mechanisms, and overall system performance.

### FIELD OF THE INVENTION

This invention concerns new and enhanced AI neural networks integrated with Distributed Ledger Technology (“DLT”) applications.

### BACKGROUND OF THE INVENTION

Neural networks, a subset of artificial intelligence, have gained significant attention and recognition for their remarkable ability to emulate human-like learning and decision-making processes. Inspired by the complex neural connections in the human brain, these computational models are designed to process and analyze vast amounts of data, recognize patterns, and make predictions or classifications. Neural networks have found applications in diverse fields, including image and speech recognition, natural language processing, recommendation systems, financial forecasting, and medical diagnosis. Their adaptability and capacity to uncover hidden relationships in data may make them a powerful tool for solving complex problems and driving innovation in various industries.

Problems may occur, however, in the applications of neural networks to different situations. For example, neural networks may require huge models with many parameters and big data for their proper training. This may limit the use of neural networks to large, well-funded institutions with the capacity for high performance infrastructure. This goes against the goal that these neural networks should be useful in decentralized, open communities with commodity hardware. Better and more efficient data processing and analysis, in real time and otherwise, are needed.

Another issue with existing neural network systems can be with security, privacy and trust among users, when sensitive data can be leaked for financial exploitation or otherwise create security issues. Protection against breaches, unauthorized access and data manipulation is needed. Neural networks could be improved with better data security, fraud detection transparency (e.g., tracing and verifying transactions and fairness) and decision-making capabilities to improve trust and reliability of the system.

There is a need for new neural networks that overcome some or all of the problems and issues with existing neural networks. One aspect of embodiments of this invention is to address certain of these problems and issues with DLT. DLT refers to technological infrastructure and protocols that allow simultaneous access, validation, and record updating across a networked database. DLT is the technology that blockchains are created from, and the infrastructure allows users to view any changes and who made them, reduces the need to audit data, ensures data reliability, and limits access to those in need.

It is an object of this invention to improve neural networks with the application of DLT to them to achieve benefits for the users. Such benefits could include enhanced decentralization, data ownership, security, transparency, adaptive learning, efficiency, accuracy, responsiveness, and fault tolerance. It is another object of this invention to provide new and improved neural networks that solve some or all of the problems encountered with them while also maintaining the ability to use them with open communities of individuals and commodity hardware with more efficiency and accuracy.

These, and other objects and advantages are achieved with embodiments of this invention, as set forth herein and as will be apparent to a person of skill in the art after access to this disclosure.

### SUMMARY OF THE INVENTION

Certain embodiments of this invention introduce a new AI neural network architecture called Neural Consensus Network (NCN), see FIG. 5. Additionally, the invention embodies an integration of neural networks onto DLT, leveraging the innovative concepts of Neural Smart Contracts and novel Neural Consensus Algorithms. This integration marks a significant advancement in governance systems, combining the power of neural networks with the transparency, decentralization, and security provided by DLT technology and smart contracts.

The architecture of certain embodiments of this invention encompasses multiple layers that seamlessly work together. At the data collection layer, relevant governance data, including laws, regulations, policies, and historical records, is gathered using metadata tags such as hashtags for efficient organization and analysis.

The AI neural network layer plays a crucial role in processing the collected data. Algorithms and machine learning techniques are employed, with hashtags serving as input features. By learning patterns and trends from hashtag usage, the neural network generates valuable insights, predictions, and recommendations to inform governance decisions.

The integration with the DLT is facilitated by the integration layer. This layer ensures transparency, immutability, and security by utilizing a distributed ledger, such as Ethereum or Hyperledger, to record and verify transactions. At the core of this integration are Neural Smart Contracts, which automate governance processes, enforce rules, and enable secure and transparent transactions.

To further enhance the governance system, Neural Consensus Algorithms are incorporated. These algorithms, specifically designed for neural networks, enable agreement and coordination among network participants, ensuring the integrity and accuracy of the neural network's outputs.

In certain embodiments, a decision-making module is provided, enriched with decision-making algorithms and resource allocation mechanisms, which, in some applications, promotes citizen participation through secure and decentralized voting mechanisms. This inclusive approach strengthens the democratic nature of the governance system.

To address security and privacy concerns, certain embodiments of the invention integrate cryptographic systems, guaranteeing user anonymity and enabling programmable, secure, anonymous, and decentralized operations throughout the system.

The integration of neural networks, Neural Smart Contracts, and Neural Consensus Algorithms onto the DLT offers a wide array of key features and benefits. It enables enhanced data analysis, transparency, accountability, and efficiency in decision-making processes. With applications in secure elections, decentralized governance, financial systems, and corporate governance, this integration empowers citizens, fosters trust, and strengthens governance systems across various domains. This provides a system for integrating a plurality of neural networks, neural smart contracts, oracles, and neural consensus algorithms onto a DLT distributed ledger, creating a decentralized framework (e.g., using the Genesis resources) comprising a network of AI nodes. The decentralized (e.g., Genesis) framework embodiments expand as the system grows and matures, accommodating an increasing number of AI nodes and fostering a distributed and collaborative environment.

The integration of neural networks, Neural Smart Contracts, and Neural Consensus Algorithms onto the DLT represents a paradigm shift in governance systems. By combining advanced data analysis, transparency, decentralization, security, and the automation capabilities of Neural Smart Contracts, preferred embodiments of this invention revolutionizes decision-making processes, empowers citizens, and ensures the integrity and accountability of governance systems in the digital age.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a diagram showing an embodiment of the integration of neural consensus onto DLT, illustrating key components and their interactions within the system.

FIG. 2 is a graphic showing the integration of AI with DLT of this invention.

FIG. 3 is a graphic that illustrates examples of embodiments and applications of this invention, which include novel neural algorithms such as secure elections, token creation, financial transactions (e.g., TGcoin, an example of a decentralized financial payment network), carbon credit transactions and regulatory forensic accounting.

FIG. 4 is a diagram of an embodiment of this invention with four components and certain of their interactions shown.

FIG. 5 is a diagram showing a comprehensive neural network integration procedure onto DLT.

FIG. 6 is a diagram showing a simplified procedure for certain embodiments of this inventions and neural network integration onto DLT.

FIG. 7 is a diagram that further illustrates step 1 of the neural network integration procedures of certain embodiments of this invention onto DLT: Determine Neural Network.

FIG. 8 is a diagram that further illustrates step 2 of the neural network integration procedures of certain embodiments of this invention onto DLT: Data Collection and Processing.

FIG. 9 is a diagram that further illustrates step 3 of the neural network integration procedures of certain embodiments of this invention onto DLT: AI Neural Network Processing.

FIG. 10 is a diagram that further illustrates step 4 of the neural network integration procedures of certain embodiments of this invention onto DLT: AI Neural Network Training.

FIG. 11 is a diagram that further illustrates step 5 of the neural network integration procedures of certain embodiments of this invention onto DLT: Selection of Consensus Mechanism.

FIG. 12 is a diagram that further illustrates step 6 of the neural network integration procedures of certain embodiments of this invention onto DLT: Transaction Validation.

FIG. 13 is a diagram that further illustrates step 7 of the neural network integration procedures of certain embodiments of this invention onto DLT: Neural Smart Contract & Consensus Generation.

FIG. 14 is a diagram that further illustrates step 8 of the neural network integration procedures of certain embodiments of this invention onto DLT: Integration Options—Neural Smart Contracts and Neural Consensus.

FIG. 15 is a flowchart concerning the integration of neural networks for secure elections on an AI (e.g., Genesis) blockchain/distributed ledger of an embodiment of this invention.

FIG. 16 is a flowchart concerning a financial neural network (e.g., TGcoin) integration for secure and compliant transactions on an AI (e.g., Genesis) blockchain/distributed ledger of an embodiment of this invention.

FIG. 17 is a flowchart concerning the integration of a neural network for cargo handling on an AI (e.g., Genesis) blockchain/distributed ledger.

FIG. 18 is a flowchart concerning the integration of a neural network for tokenizing assets on an AI (e.g., Genesis) blockchain/distributed ledger.

FIG. 19 is a code snippet of an embodiment of this invention that illustrates the integration of the AI neural network into the DLT: importing dependencies.

FIG. 20 is a code snippet of an embodiment of this invention that illustrates the integration of the AI neural network into the DLT: neural network architecture.

FIG. 21 is a code snippet of an embodiment of this invention that illustrates the integration of the AI neural network into the DLT: data collection and preprocessing.

FIG. 22 is a code snippet of an embodiment of this invention that illustrates the integration of the AI neural network into the DLT: training the neural network.

FIG. 23 is a code snippet of an embodiment of this invention that illustrates the integration of the AI neural network into the DLT: smart contract integration.

FIG. 24 is a code snippet of an embodiment of this invention that illustrates the integration of the AI neural network into the DLT: submit transaction to the DLT with oracle integration.

FIG. 25 is a code snippet of an embodiment of this invention that illustrates the integration of the AI neural network into the DLT: integration of a neural consensus mechanism into a distributed system, part 1.

FIG. 26 is a code snippet of an embodiment of this invention that illustrates the integration of the AI neural network into the DLT: integration of a neural consensus mechanism into a distributed system, part 2.

### DETAILED DESCRIPTION OF THE INVENTION

In certain embodiments of this invention, the integration of the AI neural network to create a new system, from components of one or more existing systems, addresses a crucial challenge in enhancing the efficiency, accuracy, and security of the system. In today's rapidly evolving technological landscape, the need for advanced data analysis and decision-making capabilities is paramount. Traditional methods often fall short in effectively processing and interpreting complex data sets, leading to suboptimal outcomes. By integrating the AI neural network, certain embodiments of this invention can revolutionize the system by harnessing the power of artificial intelligence and deep learning algorithms.

The significance of this integration lies in its ability to unlock new levels of efficiency, accuracy, and security. The resulting AI neural network of embodiments of this invention is designed to handle large volumes of data, analyze intricate patterns, and make informed decisions based on learned behaviors. This integration enables the system to process complex data sets at unprecedented speed, providing real-time insights and actionable intelligence.

Moreover, the AI neural network integration strengthens the security measures of the system. By leveraging advanced machine learning techniques, the neural network can detect and flag potential security threats, unauthorized access attempts, or suspicious activities. This proactive approach enhances the system's resilience and safeguards sensitive data from potential breaches.

The integration of the AI neural network represents a significant advancement in data analysis and decision-making capabilities. It offers the potential to unlock valuable insights, optimize processes, and ensure the integrity of the system. Through this integration, certain embodiments of this invention can establish a new standard of excellence in the field, driving innovation and maximizing the potential of the new system that is created.

By combining the power of AI neural networks with components of existing systems, certain embodiments of this invention can leverage their ability to process vast amounts of data, identify patterns, and make accurate predictions. This integration empowers decision-makers with valuable information and insights, enabling them to make data-driven decisions that yield better outcomes.

Furthermore, the integration of AI neural networks in these embodiments enhances the system's adaptability and responsiveness. These networks can continuously learn and improve their performance over time, ensuring that the system remains up to date with evolving data and trends. This adaptability enables the system to stay ahead of challenges and make proactive adjustments when necessary.

In certain preferred embodiments of this invention, the integration of AI neural networks into components of an existing system represents a significant leap forward in data analysis, decision-making, and system security. By leveraging the power of artificial intelligence, these embodiments can unlock new possibilities and drive innovation in various fields. This integration positions certain embodiments of this invention at the forefront of technological advancement, enabling these embodiments to provide efficient, accurate, and secure solutions that meet the evolving needs of users.

The existing systems face several technical challenges and shortcomings that hinder their efficiency, security, and overall performance. These challenges include data security vulnerabilities, limited fraud detection capabilities, lack of transparency, and inadequate decision-making processes. These shortcomings undermine the trust and reliability of the system, posing significant risks and hindering its potential.

One of the primary problems is data security. Existing systems often struggle to provide robust protection for sensitive information, making them susceptible to breaches, unauthorized access, and data manipulation. This compromises the integrity of the system and erodes user trust. Additionally, the lack of effective fraud detection mechanisms leaves the system vulnerable to fraudulent activities, leading to financial losses and reputational damage.

Transparency is another critical issue. Many existing systems lack transparency, making it difficult to trace and verify transactions or ensure the fairness of processes. This opacity undermines accountability and can foster an environment conducive to corruption or unethical behavior.

Furthermore, the current decision-making processes within systems often rely on limited data analysis capabilities, leading to suboptimal outcomes. Inefficient data processing and analysis hinder the ability to derive meaningful insights and make informed decisions in real-time, impeding the system's overall efficiency and effectiveness.

The integration of the AI neural network in certain embodiments of this invention aims to overcome these challenges and address the shortcomings of the existing systems. By incorporating advanced machine learning algorithms, the neural network enhances data security, detects and prevents fraudulent activities, promotes transparency, and enables more robust and accurate decision-making processes. The new neural network's ability to analyze vast amounts of data, identify patterns, and make informed predictions enhances the system's efficiency, accuracy, and responsiveness.

Additionally, the integration of AI neural networks in certain embodiments of this invention introduces adaptive learning capabilities, allowing the system to continuously improve and adapt to changing circumstances. This adaptability ensures that the system remains up to date with evolving data and trends, enabling it to make proactive adjustments and optimize its performance.

Overall, the integration of AI neural networks in certain embodiments of this invention addresses the technical challenges and shortcomings of the existing systems, providing a more secure, transparent, and efficient solution. By leveraging the power of advanced data analysis and decision-making capabilities, these embodiments can be used to create a new and improved system that inspires trust, delivers optimal performance, and meets the evolving needs of users in various domains.

The AI neural network integration into the components of existing systems of certain embodiments of this invention addresses various technical challenges and shortcomings, enhancing efficiency, security, and overall performance. The integration aims to overcome issues such as data security vulnerabilities, limited fraud detection capabilities, lack of transparency, and inadequate decision-making processes, which have hindered the system's potential.

### Technical Aspects of Certain Preferred Embodiments

The AI neural network of certain embodiments of this invention can serve as a sophisticated machine learning model, utilizing advanced algorithms and techniques to enable accurate data analysis, fraud detection, and decision-making capabilities within the integrated system. The technical process comprises several key steps in these embodiments:

1. Defining the Objective: Prior to integration, a pre-integration process involves defining the objective of the integration. This step sets the stage for the subsequent integration steps, ensuring alignment between the system's goals and the capabilities of the AI neural network.

2. Data Collection and (Pre) Processing: The AI neural network relies on comprehensive data collection and processing to train and operate effectively. In certain embodiments, this is done by a data collection module. Relevant datasets containing transaction records, financial indicators, and other data points are collected from various sources. These datasets are carefully curated and preprocessed to ensure data quality and consistency.

3. AI Neural Network Processing: Once the data is prepared, it is fed into the neural network for processing. The neural network consists of multiple layers, including input layers, hidden layers (such as convolutional layers, recurrent layers, or fully connected layers), and output layers. In certain embodiments, this is done by one or more AI neural network modules. Each layer performs specific computations and transformations on the input data, allowing the network to learn and extract meaningful patterns and features.

4. AI Neural Network Training: Following the data processing step, the AI neural network (e.g., AI neural network module) undergoes training. The network is trained using labeled data, where the desired outputs or targets are known. Through an iterative process, the neural network adjusts its internal parameters to minimize the difference between predicted outputs and the true labels. This optimization is achieved using algorithms like backpropagation and gradient descent. The training process helps the neural network learn from the data and improve its ability to make accurate predictions or classifications.

5. Neural Consensus Selection: After the neural network training, the system proceeds to select an appropriate neural consensus mechanism. In certain embodiments, this is performed by a neural consensus module and/or a transaction validation module (combined into one module or separated into two or more modules). The selection process involves evaluating and choosing a consensus algorithm that aligns with the system's requirements and objectives. The neural consensus mechanism is responsible for achieving consensus within the integrated system and validating transactions.

6. Transaction Validation: Once the neural consensus mechanism is selected, the system moves on to the transaction validation step. In certain embodiments, this is done by a transaction validation module which may be separate or the same as the neural consensus module. In this step, the integrated system collectively validates the transactions, ensuring their accuracy and adherence to the established rules. This validation process contributes to the integrity and security of the overall system.

7. DLT Integration and Neural Smart Contracts: Following the transaction validation, the next step involves integrating the trained neural network with a DLT system. This integration is facilitated through the use of neural smart contracts, which are self-executing contracts with the terms of the agreement directly written into code. These contracts define the rules, conditions, and logic for executing transactions within the DLT. Neural smart contracts enable the enforcement of specific behaviors, verification of transaction validity, and triggering of actions based on the neural network's predictions or decisions. In certain embodiments, this integration and neural smart contracts use is performed by an integration and neural smart contracts DLT module.

8. DLT Integration: The final step in these embodiments includes integrating the neural smart contracts and selected neural consensus mechanism onto a DLT system, such as the (e.g., Genesis) DLT embodiments of this invention. This integration allows for seamless collaboration between the DLT and the neural network, providing secure and efficient data-driven operations. In certain embodiments, this integration is performed by the integration and neural smart contracts DLT module.

By combining data collection and processing, AI neural network processing, AI neural network training, neural consensus selection, transaction validation, DLT integration with neural smart contracts, and the integration onto a DLT system, such as the (e.g., Genesis) DLT embodiments of this invention, the system achieves robust and secure operations. It empowers accurate decision-making, fraud detection, efficient transaction processing, and consensus within the network, providing significant benefits to various applications in finance, voting systems, and other domains. The integration of neural networks, neural smart contracts, and neural consensus mechanisms represents a cutting-edge innovation that addresses the limitations of traditional systems and opens up new possibilities for secure and efficient data-driven operations.

The flowcharts in the figures and descriptions herein encompass the steps and capture embodiments of the comprehensive integration process. It begins with data collection and processing (e.g., preprocessing), followed by AI neural network processing and training. The next steps involve the selection of a neural consensus mechanism, transaction validation, DLT integration with neural smart contracts, and the final integration onto a DLT system, such as the (e.g., Genesis) DLT embodiments of this invention.

Additionally, the flowcharts and descriptions emphasize the bidirectional flow of information between the DLT and the neural network, indicating that the neural network receives feedback, updates, or relevant information from the integrated components and the DLT. This demonstrates the flexibility and versatility of the resulting AI system, such as the Genesis system example/embodiment of this invention, showcasing the different scenarios for integrating neural networks with the DLT. Each integration option offers unique advantages and capabilities, enabling advanced intelligence, secure transactions, and distributed agreement within the DLT ecosystem.

The integration process comprises a number of steps involved and shows the benefits of integrating AI neural networks with DLT. By leveraging the power of neural networks, smart contracts, and consensus mechanisms, the integrated system offers improved security, transparency, and efficiency in data-driven operations, laying the foundation for the development of innovative applications across various industries.

### Certain Distributed Ledger Integration Embodiments and Benefits Therefrom

The integration of the AI neural network with DLT brings numerous benefits to the system, enhancing security, integrity, and transparency. DLT offers key concepts and advantages that contribute to the integration:

Data Immutability: DLT ensures that once data is recorded on the ledger, it becomes immutable and resistant to unauthorized alterations, ensuring the integrity and trustworthiness of processed data and transaction records.

Decentralization: By integrating the AI neural network with DLT, the system leverages the decentralized network of nodes. This eliminates the reliance on a central authority, minimizes the risk of a single point of failure, and enhances system resilience and security through the distribution of data and computations.

Transparency: DLT provides all participants in the network with consistent and synchronized access to the ledger, enabling auditing, verification, and oversight of operations performed by the AI neural network. This transparency allows participants to validate the system's integrity and ensure compliance with predefined rules and regulations.

The integration of the AI neural network with DLT harnesses these inherent features to strengthen the overall system. It establishes a robust foundation for deploying neural smart contracts, automating transaction validation and execution based on predefined rules. This integration fosters trust among participants and creates an efficient and reliable ecosystem for data processing and transaction management.

Consensus algorithms play a significant role in ensuring agreement and validation within the network during the integration process. In the context of AI neural network and DLT integration, both neural consensus algorithms and common consensus algorithms can be utilized.

Neural consensus algorithms leverage the neural network's advanced capabilities to reach agreement within the integrated system. Combining consensus mechanisms with the intelligence of the neural network enhances decision-making and validation processes, ensuring accurate and reliable outcomes. The neural network's pattern recognition and data analysis capabilities contribute to the integrity and transparency of the consensus mechanism.

Common consensus algorithms, such as Proof of Work (PoW) or Proof of Stake (POS), can also be integrated into the system. These algorithms facilitate agreement and validation through computational or stake-based mechanisms, ensuring consensus on the ledger's state and transaction validity. Common consensus algorithms offer advantages such as energy efficiency or scalability and can be used in conjunction with neural consensus algorithms for a robust and efficient integration within the Neural Consensus Network architecture.

The integration of neural and/or common consensus algorithms enhances the security and reliability of the overall system, ensuring validated and agreed-upon transactions added to the immutable ledger consistently and trustworthily. Incorporating consensus algorithms into the integration process establishes a strong foundation for secure and efficient data-driven operations, fostering trust and enabling a wide range of innovative and reliable applications across various industries.

In certain embodiments of this invention, the integration of AI neural networks and DLT benefits from DLT's inherent features and the selection and integration of suitable neural and/or common consensus algorithms. This combined approach enhances the security, integrity, and performance of the integrated system, enabling innovative and reliable applications in the digital age.

### Certain System Architecture Embodiments

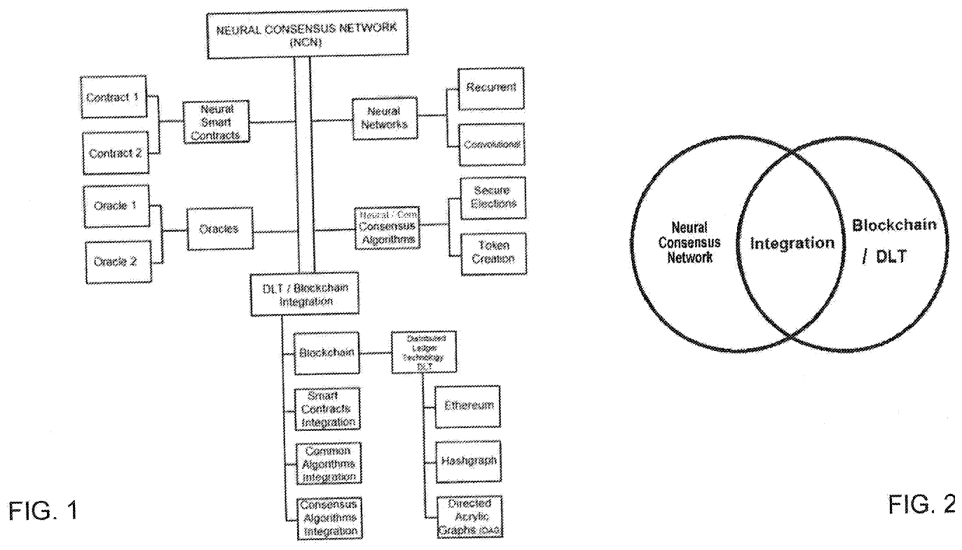

FIG. 1 illustrates key components of a DLT system embodiment of this invention. It is named Neural Consensus Network (NCN). It shows key components and their interactions on the diagram, which include an AI Neural Networks, Neural Smart Contracts, Neural Consensus Algorithms, Oracles, blockchain, and the DLT. On the FIG. 2 graphic on the left, a representation of the integration of AI with DLT is illustrated. The 6 main components used in certain preferred embodiments, can be described as follows:

1. Neural Consensus Network: The neural consensus network is a core component that performs data processing, analysis, and decision-making using advanced algorithms and neural network models. It extracts meaningful insights from input data and plays a vital role in the functioning of the system. It can be implemented in certain embodiments as an AI neural network module.

2. Neural Networks: The Neural Consensus Network (NCN) demonstrates versatility by seamlessly integrating various neural networks or combinations thereof into a Distributed Ledger Technology (DLT) ecosystem. As illustrated in FIG. 1, two examples utilize recurrent neural networks (RNNs) for sequential data analysis, facilitating efficient processing of dynamic information. Below the recurrent neural network, convolutional neural networks (CNNs) are employed to enhance the system's capability for structured data processing. These are just two examples of the numerous neural networks that can extend the capabilities of the NCN. This adaptability empowers the NCN to address a wide range of data types and tasks, establishing it as a potent tool for data processing, analysis, and decision-making within the DLT framework.

3. Neural Smart Contracts: Within the Neural Consensus Network (NCN) architecture, Neural Smart Contracts serve as programmable code deployed on the (e.g., Genesis) DLT. These contracts are dynamically generated and overseen by the neural network, drawing upon input data from diverse sources. They are designed to enforce predetermined rules and conditions, leveraging the neural network's capabilities to significantly enhance their accuracy and dependability. What sets the NCN apart is its ability to produce multiple smart contracts, as indicated by the two boxes labeled ‘Contract 1’ and ‘Contract 2’ to the left of the Neural Smart Contract box, showcasing its adaptability and flexibility to cater to various requirements. In specific implementations, these contracts can be considered part of an integrated Neural Smart Contracts DLT module.

4. Neural Consensus Mechanisms: Neural Consensus Mechanisms are algorithms integrated into the (e.g., Genesis) DLT system that leverage the neural network's intelligence for consensus and validation purposes. These mechanisms utilize the pattern recognition and data analysis capabilities of the neural network to reach agreement among network participants and ensure the integrity of transactions and data. This can be implemented in certain embodiments in a neural consensus module, that may use neural consensus mechanisms alone or combined with common consensus mechanisms in such a module. This versatile approach is exemplified through two distinct neural consensus algorithms: ‘Secure Elections’ and ‘Token Creation,’ both of which illustrate the adaptability and functionality of the Neural Consensus Network, wherein Secure Election and Token Creation are neural consensus algorithms.

5. DLT Embodiments: Blockchain is included as a sub-category, while other DLT embodiments of this invention form the foundation of the system which is a broader category that encompasses various technologies for distributed, decentralized, and secure record-keeping such as Directed Acrylic Graphs (DAGs), Hashgraph, and Ethereum, serving as examples in the graph. It provides a decentralized and secure infrastructure for storing and processing data. The DLT maintains a distributed ledger, recording all validated transactions and the execution of Neural Smart Contracts. It ensures transparency, immutability, and reliability in the system. Towards the lower section of the diagram, an additional trio of boxes illustrates the integration of Neural Smart Contracts, Common Algorithms, and Consensus Algorithms.

6. Oracles. Oracles within the Neural Consensus Network (NCN) serve as trusted data bridges, with “Oracle 1” and “Oracle 2” to the left, showcasing the system's versatility, sourcing real-world information and feeding it into the network's consensus mechanisms. They enable the NCN to make informed, data-driven decisions by providing timely and accurate external data, enhancing transparency and reliability across various applications.

The integration of these key components—the Neural Network, Neural Smart Contracts, Neural Consensus Mechanisms, and the (e.g., Genesis) DLT-offers a flexible and adaptable system for data processing, decision-making, and transaction management. The architecture allows for different approaches to integrate the neural network into the (e.g., Genesis) DLT ecosystem, providing options based on specific requirements and use cases.

One approach is through Neural Smart Contracts, where the neural network generates programmable code that is deployed on the (e.g., Genesis) DLT. These contracts incorporate input data from various sources and leverage the neural network's capabilities to enforce predefined rules and enhance accuracy and reliability. This integration method enables seamless execution of agreements and automated actions within the DLT network.

Alternatively, or in addition, the integration can also occur through Neural Consensus Mechanisms. In this scenario, the neural network's intelligence is harnessed for consensus and validation purposes within the (e.g., Genesis) DLT system. The neural consensus mechanisms utilize pattern recognition and data analysis capabilities to facilitate agreement among network participants, ensuring transaction integrity and data reliability.

Additionally, a hybrid approach involving methods that combine Neural Smart Contracts and Neural Consensus Mechanisms, where Neural Smart Contracts handle specific tasks within the DLT, while Neural Consensus Mechanisms provide consensus and validation using the neural network's intelligence.

By offering these integration options, the system caters to diverse requirements and allows for customization based on specific needs. Whether through Neural Smart Contracts or Neural Consensus Mechanisms, the integration of the neural network enhances the capabilities of the (e.g., Genesis) DLT, enabling it to provide secure, efficient, and trusted data management solutions for various applications and industries.

### Certain System Operations Embodiments

### Certain System Operations Embodiments are Described Further Below:

1. Enhancing Input Data Collection: Expand the data collection process to include not only external sources such as databases or APIs but also decentralized oracles as additional data sources. This allows the system to retrieve data from multiple independent sources, increasing the diversity and reliability of the input data.

2. Augmenting Neural Network Processing: Integrate the output data provided by the decentralized oracles as an input to the neural network processing phase. This enables the neural network to leverage the data from independent sources in its analysis, enhancing the accuracy and robustness of the network's predictions or output results.

3. Data Integration in Neural Network Training: During the neural network training process, incorporate data obtained from decentralized oracles alongside the existing labeled datasets. This integration ensures that the neural network learns from both centralized and decentralized sources, improving its ability to generalize and make accurate predictions.

4. Enriching Transaction Validation: Use the data from decentralized oracles as additional information in the validation process performed by the Neural Smart Contracts. By incorporating the outputs or insights provided by the oracles, the system can enhance the accuracy and reliability of transaction validation, ensuring compliance with predefined rules and conditions.

5. Enabling Neural Smart Contract Interactions: Extend the functionalities of Neural Smart Contracts to enable interactions with decentralized oracles. This allows the smart contracts to invoke specific functions or methods within the oracles to retrieve real-time or dynamic data required for decision-making or execution of predefined actions.

6. Integrating Decentralized Oracles into Neural Consensus Algorithms: Incorporate the data obtained from decentralized oracles as inputs to the neural consensus algorithms. By leveraging the insights or output results provided by the oracles, the consensus algorithms can benefit from the neural network's analysis and decision-making capabilities, improving the consensus process's accuracy and efficiency.

7. Strengthening DLT Security: Ensure that the integration of decentralized oracles does not compromise the security measures in place. Implement appropriate security protocols and mechanisms to protect the integrity and confidentiality of the data retrieved from the oracles and maintain the overall security of the DLT system.

By integrating decentralized oracles into the existing DLT system as described above, one can enhance the reliability, accuracy, and diversity of the data used within the system. This integration also allows for leveraging the power of the neural network in analyzing decentralized data sources, improving transaction validation, consensus mechanisms, and overall system performance.

By following these steps and maintaining seamless integration between the AI neural network, Neural Smart Contract validation, and the DLT, the system ensures efficient transaction processing, secure execution of Neural Smart Contracts, and transparent recording of transactions on the DLT-based ledger.

Note: The validation process in the neural network primarily focuses on analyzing and processing input data to generate output results or predictions. It involves applying mathematical operations, activation functions, and learned models to the input data. The neural network's validation aims to ensure the accuracy and reliability of the predictions or results it produces.

On the other hand, the validation process within the DLT is responsible for verifying the legitimacy and compliance of transactions before they are recorded on the DLT. This validation ensures that transactions adhere to the predefined rules and conditions set by the neural smart contracts and the consensus rules of the DLT. The DLT's validation may involve checks such as verifying digital signatures, checking for sufficient funds, validating the authenticity of transaction data, and enforcing business rules or regulations.

While there may be similarities in terms of the objective of validation, the processes and criteria used for validation differ between the neural network and the DLT. The neural network focuses on data analysis and prediction accuracy, while the DLT validation is concerned with transaction legitimacy and compliance with predefined rules.

Therefore, in a system integrating a neural network and a DLT, dual validation processes are performed by each component, serving their specific purposes and contributing to the overall integrity and functionality of the system. By integrating decentralized oracles into the existing DLT system as outlined above, one can augment the dependability, precision, and variety of the data employed within the system. This integration also enables harnessing the capabilities of the neural network to analyze decentralized data sources, thereby enhancing transaction validation, consensus mechanisms, and the overall performance of the system.

By following these steps and ensuring seamless integration between the AI neural network, Neural Smart Contract validation, and the DLT, the system guarantees efficient transaction processing, secure execution of Neural Smart Contracts, and transparent recording of transactions on the DLT-based ledger.

It is important to note that the validation process within the neural network primarily focuses on analyzing and processing input data to generate accurate output results or predictions. This involves applying mathematical operations, activation functions, and learned models to the input data. The neural network's validation aims to ensure the reliability and precision of the predictions or results it produces.

On the other hand, the validation process within the DLT is responsible for verifying the authenticity and compliance of transactions before they are recorded on the DLT. This validation ensures that transactions adhere to the predefined rules and conditions set by the neural smart contracts and the consensus rules of the DLT. The DLT's validation may include checks such as verifying digital signatures, confirming sufficient funds, validating the integrity of transaction data, and enforcing business rules or regulatory requirements.

As indicated above, while both the neural network and the DLT share the objective of validation, the processes and criteria used for validation differ between the two. The neural network focuses on data analysis and prediction accuracy, while the DLT validation is concerned with transaction legitimacy and adherence to predefined rules.

Hence, in a system that integrates a neural network and a DLT, dual validation processes are performed by each component, serving their specific purposes and contributing to the overall integrity and functionality of the system.

DLT offers a transformative approach to transaction processing, accuracy, efficiency, and decision-making through the integration of an AI neural network. This integration is visually represented by the flowchart in the figures showing the process flow and illustrating the key stages of the system's operation within the DLT network.

### Certain Process/Work Flow Embodiments

Certain process/work flow embodiments are described below, comprising a number of steps:

1. Request Initiation: The process commences with the initiation of a transaction request, ensuring its authenticity and validity.

2. Neural Network and Neural Consensus Algorithm Block: A smart contract block is created, incorporating the functionality of the AI neural network and neural consensus algorithm(s). This block contains the necessary code for analysis, validation, decision-making, and consensus achieved through the neural consensus algorithm(s). The AI neural network and neural consensus algorithm(s) work together to process the data, reach agreement, and make collective decisions based on predefined rules and conditions within the DLT system.

3. AI Neural Network Analysis, Validation, and Decision-making with Oracles: The AI neural network processes the data, conducting analysis, validation, and decision-making based on predefined rules and conditions. It leverages decentralized oracles to access external data sources, ensuring the accuracy and reliability of the information used in the analysis and decision-making process.

4 Transaction Block Creation: Upon completion of the analysis and decision-making, a transaction block is generated, containing relevant transaction details.

5. Transaction Block Distribution: The neural smart contract block and the transaction block are distributed to all nodes in the network using a peer-to-peer communication protocol.

6. Transaction Validation with Decentralized Oracles: Each node independently validates the transaction block, utilizing decentralized oracles to verify and validate the data from multiple independent sources. This validation process ensures compliance with predefined rules, consensus mechanisms, and data accuracy within the DLT system.

7. Reward for Proof of Work: Participating nodes that contribute computational resources to secure the DLT, using mechanisms such as proof-of-work or other consensus algorithms, are rewarded for their efforts.

8. DLT Update: After successful validation, the transaction block is added to the existing DLT as a new block, creating an unalterable chain of verified transactions.

9. Network-wide Update: The updated DLT is propagated across the network, ensuring that all participating nodes have the most recent version of the distributed ledger.

10. Transaction Completion: Once the transaction is successfully added to the DLT, it is considered complete within the DLT system.

By following this flowchart and maintaining a seamless integration between the AI neural network, transaction validation, and the distributed ledger, the system ensures efficient transaction processing, secure execution of neural smart contracts, and transparent recording of transactions on the DLT-based ledger. This integration empowers the DLT network with enhanced capabilities, combining the power of AI analysis and decision-making with the transparency, decentralization, and immutability provided by the DLT technology.

### Unique Feature and Innovations of Certain Preferred Embodiments

The integration of the AI neural network onto the DLT introduces several unique features and technical innovations in certain preferred embodiments that enhance the overall functionality, security, and efficiency of the system. These innovations include:

a) Novel Algorithms: The AI neural network integration incorporates state-of-the-art algorithms specifically tailored for fraud detection, data analysis, and decision-making. These algorithms leverage advanced machine learning techniques such as deep learning, reinforcement learning, and generative adversarial networks (GANs) to effectively handle complex data patterns, temporal dependencies, and adversarial scenarios.

b) Advanced Data Preprocessing Techniques: The integration employs advanced data preprocessing techniques to ensure the quality and suitability of input data for neural network training and processing. These techniques include data cleaning, normalization, feature extraction, and dimensionality reduction, which optimize the data representation and improve the neural network's performance.

c) Novel Consensus Mechanisms: The integration leverages novel neural consensus algorithms and non-neural consensus mechanisms which are inherent to the DLT. These mechanisms ensure that all network participants agree on the validity and order of transactions, providing a decentralized and trustless environment for executing smart contracts and maintaining the integrity of the system. These novel consensus algorithms can incorporate machine learning techniques, artificial intelligence, or decentralized decision-making processes, enabling the network to make more sophisticated and context-aware decisions without the need for explicit smart contract rules.

In this sense, novel consensus algorithms have the potential to replace or enhance the role of smart contracts by providing more dynamic and adaptable decision-making capabilities directly within the consensus process. This can lead to more efficient, scalable, and intelligent decentralized systems. However, it's important to note that the exact role and impact of novel consensus algorithms in relation to smart contracts will depend on the specific use cases, requirements, and advancements in the field of decentralized technologies. The role and impact of novel consensus algorithms in relation to smart contracts will depend on specific use cases, requirements, and advancements in the field of decentralized technologies.

d) Integration of Decentralized Oracles: The AI neural network integration incorporates the integration of decentralized oracles, which act as bridges connecting the DLT with external data sources. These oracles fetch and verify off-chain data, allowing the AI neural network to access real-world information for analysis and decision-making. The integration of oracles enhances the system's ability to leverage real-time data, such as market prices, weather conditions, and IoT device readings, to trigger and execute smart contract functions based on external events.

e) Enhanced Security Measures: The AI neural network integration incorporates robust security measures to safeguard sensitive data and prevent unauthorized access. Encryption techniques, secure data transmission protocols, and access control mechanisms are implemented to protect the confidentiality, integrity, and privacy of the data throughout its lifecycle.

f) Transparent and Auditable Transactions: The DLT layer in the integration enables transparent and auditable transactions. Each validated transaction and smart contract execution is recorded on the immutable DLT ledger, providing a transparent trail of activities that can be audited for accountability and compliance purposes.

g) Scalability and Performance Optimization: The AI neural network integration considers scalability and performance optimization to handle large-scale data processing and complex computations. Techniques such as parallel computing, distributed neural networks, and optimized algorithms are employed to efficiently utilize computational resources and achieve high-speed processing.

h) Neural Smart Contracts are an evolution of smart contracts that integrate AI neural networks into the execution and decision-making processes. While smart contracts operate based on predefined rules and conditions, neural smart contracts leverage the capabilities of AI to analyze data, extract insights, and make more complex and dynamic decisions. By integrating neural networks, these contracts can adapt and learn from patterns and data, enhancing their decision-making capabilities over time.

The key difference between smart contracts and neural smart contracts lies in the inclusion of AI neural networks. Neural smart contracts utilize machine learning techniques, such as deep learning, to process and analyze data, identify patterns, and make predictions or recommendations. This integration enables them to handle more sophisticated and data-intensive scenarios that traditional smart contracts may not be able to address effectively.

Preferred Embodiments with Neural Smart Contracts

Certain embodiments of this invention use neural smart contracts that offer several advantages over common smart contracts:

1. Enhanced Decision-Making: The integration of neural networks enables neural smart contracts to make more informed and context-aware decisions. By analyzing large volumes of data and recognizing patterns, neural smart contracts can provide more accurate and intelligent decision-making capabilities.

2. Adaptability and Learning: Neural smart contracts have the ability to adapt and learn from new data. They can update their internal state and decision-making processes based on feedback from the DLT or external sources. This adaptability allows the contracts to evolve and improve their performance over time.

3. Handling Complexity: Neural smart contracts are well-suited for handling complex scenarios that may involve ambiguity or uncertainty. Traditional smart contracts may struggle to handle such situations due to their deterministic nature. Neural networks can process and analyze data that might not have clear-cut rules or conditions, enabling neural smart contracts to navigate and respond to complex scenarios effectively.

4. Data Analysis and Prediction: Neural smart contracts leverage the data analysis and prediction capabilities of neural networks. They can analyze data patterns, make predictions, and generate insights, enabling more sophisticated and data-driven execution of agreements.

By integrating AI neural networks, neural smart contracts bring advanced decision-making, adaptability, and data analysis capabilities to the execution of agreements. These unique features and technical innovations set the AI neural network integration apart, enabling it to address specific challenges related to fraud detection, data analysis, and decision-making in a distributed and secure manner. The integration offers enhanced capabilities and reliable results, leading to improved efficiency, accuracy, and transparency in the system.

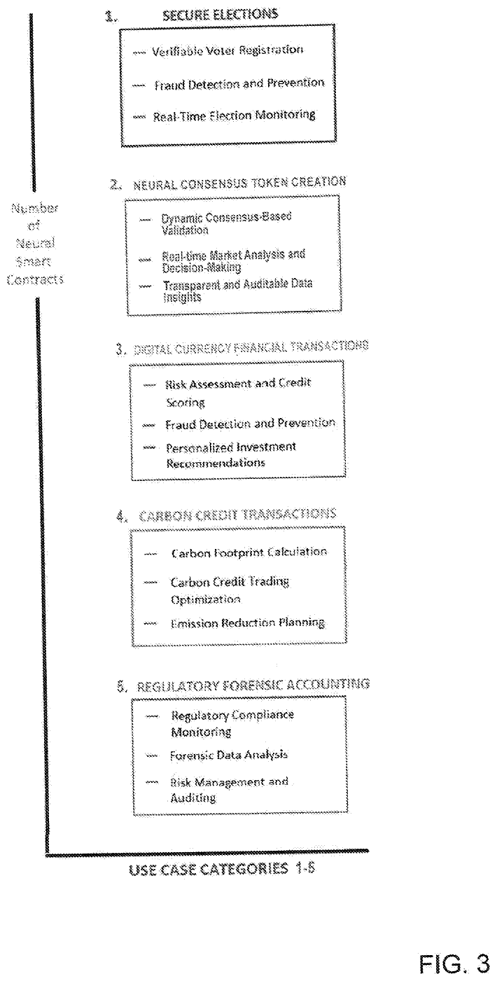

FIG. 3 refers to a graphic that illustrates embodiments and applications of this invention with examples of novel neural smart contracts and the concept of neural smart contracts and their integration with AI neural networks, showcasing the enhanced decision-making and data analysis capabilities they bring to the DLT ecosystem. The applications include 1. Secure Elections, 2. Neural Consensus Token Creation, 3.TG Coin Financial Transactions (or other digital coin systems), 4. Carbon Credit Transactions, and 5. Regulatory Forensic Accounting.

In addition to the integration of AI neural networks, the DLT also incorporates decentralized oracles, which bridge the gap between the DLT and external data sources. By leveraging oracles, the system gains access to real-world information, enabling more informed decision-making and expanding the range of applications. Oracles provide valuable data on market conditions, IoT device readings, and other external factors, empowering neural smart contracts to make dynamic and data-driven choices. This combination of AI neural networks and oracles further strengthens the system's ability to address complex challenges, such as fraud detection, data analysis, and adaptive decision-making, in a distributed and secure manner.

### Certain Embodiments Concerning Data Privacy and Security

Ensuring data privacy and security is of utmost importance within the integrated system that incorporates the AI neural network and DLT. The following measures are implemented to safeguard sensitive information and protect user data:

Encryption Techniques: To protect data confidentiality, encryption techniques are applied to sensitive data at rest and in transit. Strong encryption algorithms, such as Advanced Encryption Standard (AES) or post-quantum cryptographic algorithms, are used to encrypt data, ensuring that only authorized parties with the decryption keys can access and decipher the information.

Access Control Mechanisms: Access control measures are implemented to restrict data access to authorized individuals or entities. Role-based access control (RBAC) is commonly employed, where different user roles are assigned specific access privileges based on their responsibilities and requirements. This ensures that only authorized personnel can access sensitive data and perform specific operations.

Privacy-Enhancing Techniques: Privacy-enhancing techniques, such as data anonymization or pseudonymization, may be applied to protect the identities of individuals within the system. By replacing personally identifiable information (PII) with anonymized or pseudonymized identifiers, the system can preserve privacy while still allowing meaningful analysis and decision-making.

Within the Neural Consensus Network (NCN), there exists the capability to establish a comprehensive steering framework that enables token holders or stakeholders to optionally participate in decision-making processes. Through transparent and decentralized mechanisms like voting and smart contracts, stakeholders can collectively influence network upgrades, policy changes, and technical enhancements if they choose to do so. The NCN's steering system operates on the principles of accountability and fairness, providing the option for participants to engage in shaping the network's evolution while respecting individual preferences for involvement.

Secure Data Transmission: Secure protocols and encryption methods are used for data transmission between different components of the integrated system. Transport Layer Security (TLS) or Secure Socket Layer (SSL) protocols are commonly employed to establish secure communication channels, ensuring that data remains encrypted during transit and protected against unauthorized interception.

Compliance with Data Protection Regulations: The integrated system adheres to relevant data protection regulations, such as the General Data Protection Regulation (GDPR) or other applicable privacy laws. Compliance measures, including data handling policies, consent management, and data breach response protocols, are in place to ensure the system operates in accordance with legal requirements and respects user privacy rights.

Auditing and Monitoring: Robust auditing and monitoring mechanisms are implemented to track system activities, detect any unauthorized access attempts, and ensure compliance with security policies. Logs and audit trails are maintained, allowing for traceability and accountability in the event of security incidents or breaches. In addition to these measures, the integration of decentralized oracles plays a crucial role in ensuring data privacy and security within the system. Oracles facilitate the retrieval and verification of off-chain data, enabling the execution of smart contracts and informed decision-making while maintaining the integrity and confidentiality of the DLT network. By utilizing decentralized oracles, the system reduces the risk of single points of failure or potential manipulation, ensuring a more robust and reliable solution for accessing external data.

By implementing these data privacy and security measures, the integrated system provides a secure environment for processing, storing, and transmitting sensitive information. Data encryption, access control, privacy-enhancing techniques, secure data transmission, regulatory compliance, and auditing mechanisms work collectively to protect user data and maintain the confidentiality, integrity, and availability of information within the system.

### New Components and Methods Concerning Certain Preferred Embodiments

The integration of the AI neural network onto the DLT also presents several innovative and non-obvious technical features, including the following:

Novel Neural Network Architectures: When the integration of this invention involves the development of new neural network architectures specifically tailored for the integrated system, such architectures are new. This includes novel combinations of different types of neural network layers, unique algorithms for information processing, or innovative techniques for handling specific data types or decision-making scenarios.

Innovative Data Preprocessing Techniques: Novel methodologies for data collection, preprocessing, and feature extraction are also features of this invention. This may include unique algorithms or processes for data cleaning, normalization, dimensionality reduction, or feature selection that improve the efficiency or accuracy of the neural network's analysis.

Enhanced DLT Integration: In certain embodiments of this invention, the integration of the AI neural network involves novel approaches to interact with the distributed ledger, such as specific protocols, data structures, or smart contract implementations. These innovations may improve the efficiency, security, or scalability of the DLT integration.

Privacy and Security Measures: In certain embodiments of this invention, novel techniques or methodologies for ensuring data privacy, confidentiality, and security within the integrated system are features of this invention. This may include encryption algorithms, privacy-enhancing mechanisms, access control systems, or innovative approaches for secure data transmission and storage.

Consensus Mechanisms: The integration of this invention introduces novel consensus mechanisms within the DLT, such as innovative algorithms or protocols for reaching agreement on the validity of transactions or network state. Consensus mechanisms that improve the speed, scalability, or security of the integrated system are features of embodiments of this invention. Furthermore, the integration of decentralized oracles introduces innovative technical features to this invention. The development of novel protocols, algorithms, or mechanisms for retrieving, verifying, and integrating off-chain data into the integrated system is new. These advancements in decentralized oracles contribute to the overall functionality, reliability, and security of the system, making them as valuable potential advantages of this invention.

### Certain Exemplary Preferred Embodiments and Advantages

The AI neural network integration onto the DLT brings numerous benefits and demonstrates its effectiveness in various use case scenarios. The following are some illustrative examples that highlight how the integration improves desired outcomes and delivers value

Fraud Detection and Prevention: In the financial industry, the AI neural network integration can effectively detect and prevent fraudulent activities. By analyzing historical transaction data and real-time information from the DLT, the neural network can identify suspicious patterns, anomalies, or potential fraud indicators. This enables timely intervention and reduces financial losses for individuals and organizations.

Supply Chain Transparency: The integration of the AI neural network onto the DLT enhances supply chain transparency and traceability. By leveraging the immutability and decentralized nature of the DLT, the neural network can verify the authenticity and integrity of product information, track the movement of goods, and ensure compliance with quality standards or regulatory requirements. This improves trust among stakeholders and reduces the risk of counterfeit products or unauthorized modifications.

Healthcare Diagnosis and Treatment: The AI neural network integration can revolutionize healthcare by enabling accurate diagnosis and personalized treatment plans. By analyzing medical data, patient records, and research findings stored on the DLT, the neural network can provide insights into disease patterns, predict treatment outcomes, and assist healthcare professionals in making informed decisions. This leads to improved patient care, optimized resource allocation, and advancements in medical research.

Energy Grid Optimization: The integration of the AI neural network onto the DLT can optimize energy grid operations and enhance energy management systems. By analyzing real-time data from smart meters, renewable energy sources, and grid infrastructure, the neural network can predict energy demand, optimize distribution, and facilitate peer-to-peer energy trading. This results in increased efficiency, reduced costs, and a more sustainable energy ecosystem.

Supply Chain Finance: The AI neural network integration can improve supply chain finance by enhancing trust and mitigating risks. By analyzing data from supply chain transactions, inventory levels, and financial records stored on the DLT, the neural network can assess creditworthiness, evaluate risk profiles, and automate lending processes. This enables faster access to financing, reduces operational friction, and strengthens collaboration among supply chain participants.

These examples demonstrate the versatility and value of the AI neural network integration onto the DLT, showcasing its potential to drive innovation, efficiency, and positive outcomes in various industries and domains.

Financial applications such as digital coin: The integration of the AI neural network onto the DLT brings significant advantages to financial applications such as the digital coin ecosystem. By leveraging the neural network's capabilities, TGcoin (an example of a digital coin system) can enhance its transaction validation process, remain in full financial compliance with all laws, rules and regulations, ensuring secure and reliable transactions. The neural network can analyze transaction patterns, detect suspicious activities, and mitigate the risk of fraudulent transactions. Moreover, the integration enables real-time monitoring and auditing of transactions, promoting transparency and accountability within the TGcoin network. This ensures the integrity of the TGcoin ecosystem and builds trust among users, making it an ideal platform for secure and efficient digital transactions. TGcoin is discussed herein as an example, but these aspects of the invention can be applied to other financial applications also.

Elections: The AI neural network integration onto the DLT has transformative implications for the electoral process. By leveraging the power of machine learning and the transparency of the DLT, it can ensure honest and secure elections. The neural network can analyze voter data, identify patterns, and detect anomalies or fraudulent activities that could compromise the integrity of the electoral process. It enables real-time monitoring of voter registration, ballot counting, and result tabulation, reducing the risk of human error and manipulation. Furthermore, the integration of neural smart contracts on the DLT can automate various election processes, such as voter verification, ballot tracking, and auditing, enhancing efficiency and trust in the electoral system.

Tokenization: Neural Consensus Tokenization. The integration of Neural Consensus Tokenization within the Neural Consensus Network architecture heralds a new era for asset digitization and trading on distributed ledger technologies (DLTs) and blockchains. Similar to the Elections example, Neural Consensus Tokenization leverages advanced AI neural networks and the transparency of DLTs to create digital representations of assets, facilitating their seamless monetization and exchange. This innovative process analyzes asset data, market trends, and external inputs through oracles to determine fair market prices, ensuring a trustworthy and efficient marketplace. Additionally, Neural Consensus Smart Contracts embedded within the DLT automate asset transactions, enhancing accessibility and reducing the need for intermediaries in asset management and trading.

These use case examples demonstrate the immense potential of the AI neural network integration onto the DLT in revolutionizing digital transactions and electoral processes. By leveraging advanced technologies and innovative approaches, TGcoin (TGcoin is an example and other digital coin systems can be used) and elections can benefit from enhanced security, transparency, and efficiency, setting new standards for their respective domains. The integration empowers individuals, organizations, and governments to leverage the power of neural networks and DLT to achieve their objectives with increased confidence and reliability.

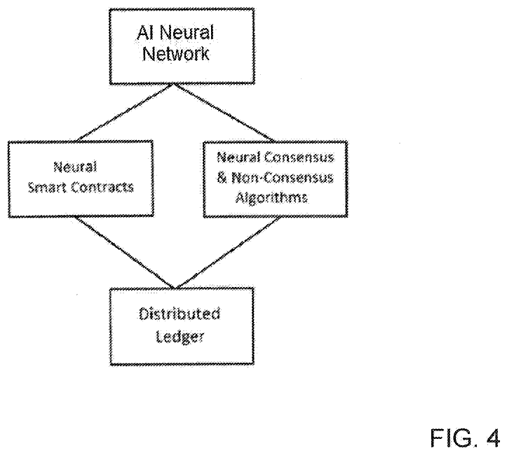

FIG. 4 illustrates key components and their interactions in an embodiment of this invention, showing the integration of neural consensus onto distributed ledgers. The components shown are an AI Neural Network, Neural Smart Contracts, the Distributed Ledger or DLT and Neural Consensus and Non-Consensus Algorithms, of the AI Genesis architecture application embodiment of this invention. Three core elements are the AI Neural Network, Neural Smart Contracts and DLT. The AI Neural Network is the artificial intelligence component of the architecture. It encompasses the algorithms, models, and data processing capabilities that enable advanced analysis, decision-making, and learning within the system. The Genesis framework is referred to herein as an example but other frameworks can also be used.

In the middle of FIG. 4 are two boxes. The first box represents Neural Smart Contracts, which are self-executing contracts encoded on the DLT with predefined rules. These contracts automate, verify, and securely execute transactions and agreements, while also integrating AI capabilities and decision-making within the DLT network. The second box represents Neural Consensus and Non-Consensus Algorithms. These algorithms are innovative approaches designed to achieve agreement on the validity of transactions or network state within the DLT network. They leverage neural network techniques to enhance the efficiency, scalability, and security of the consensus process, ensuring reliable and decentralized decision-making.

The bottom box represents the DLT, which serves as the decentralized and immutable ledger for recording transactions, storing data, and executing smart contracts. It provides a secure and transparent platform for integrating AI technologies and conducting various transactions within the network.

The FIG. 4 diagram illustrates the interactions between these components, showcasing how the AI Neural Network interacts with the Neural Smart Contracts to enable intelligent decision-making and analysis. The Smart Contracts, in turn, interact with the DLT to execute and record transactions securely. The neural consensus and non-consensus algorithms play a crucial role in facilitating efficient and reliable consensus within the network, ensuring the integrity and validity of transactions and decision outcomes.

Overall, the AI Genesis Architecture application diagram visually represents the integration of AI, smart contracts, and DLT technologies, highlighting their interconnectedness and the overall flow of information and transactions within the system.

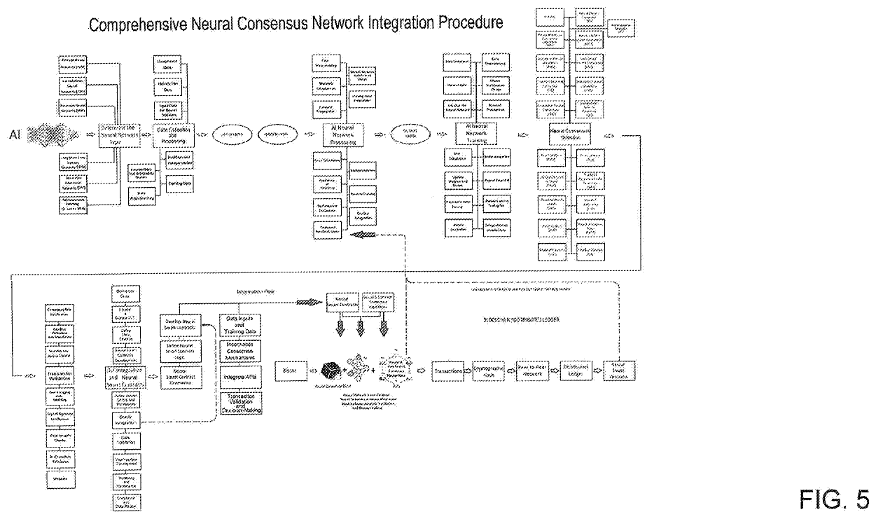

FIG. 5 is a diagram of a preferred embodiment of this invention titled “Comprehensive Neural Consensus Network Integration Procedure”. FIG. 5 provides a holistic view of the entire process of this embodiment, from choosing a neural network to integrating oracles, a Neural Smart Contract, and Neural Consensus Algorithm onto the DLT. It serves as a visual representation of certain technical steps involved in the integration journey, including the incorporation of oracles for real-time data inputs during the data collection and processing stage.

The diagram showcases the logical sequence of actions, including determining the neural network type, data collection and processing (with the inclusion of oracles for external data inputs), AI neural network processing, AI neural network training, and the integration of the Neural Smart Contract, oracles, and novel or common consensus algorithm onto the DLT. By placing oracles within the data collection and processing stage, the integration process benefits from real-time data inputs, enhancing the accuracy and relevance of the neural network's analysis and decision-making capabilities.

The step where the neural consensus mechanism is selected holds particular significance in the procedure. This step involves the integration of Neural Smart contracts, oracles, and common or novel neural consensus algorithms. By incorporating the flexibility to choose from a range of consensus options, including traditional and Neural Smart contracts, cutting-edge neural consensus algorithms, and leveraging the availability of real-time data from oracles, the integration process becomes versatile and adaptable to different use cases. This critical stage allows for the identification and choice of the most suitable consensus mechanism, considering both the neural network and the availability of real-time data from oracles.

The information loop is a critical component of the integration process of these embodiments, enabling the neural network to learn from its own outputs and refine its predictions or classifications iteratively. By incorporating the loop within a hidden layer of the network, it gains the ability to analyze its own performance, identify errors or inconsistencies, and adjust its internal parameters accordingly. This iterative feedback loop enhances the network's training efficiency, improves its capabilities, and contributes to the overall accuracy and reliability of the system. Furthermore, placing the information loop within a hidden layer adds an extra layer of security, protecting the internal workings of the model and preventing unauthorized access or manipulation. The information loop is a key feature that empowers the network to adapt, learn, and continuously improve its performance.

Further details and descriptions of the integration of oracles will be provided in the data collection and processing stage of the procedure, offering a comprehensive understanding of how external data inputs are incorporated into the neural network's analysis. The complete flowchart, incorporating oracles, serves as a valuable tool in presenting the end-to-end integration process, enabling one to gain a clear understanding of the complex and intricate nature of seamlessly integrating a neural network with a DLT while incorporating real-time data inputs. The FIG. 5 diagram showcases steps and their connections in a preferred embodiment, providing an insightful reference for comprehending the integration journey. It can be used effectively for internal documentation, presentations, or educational purposes, highlighting the new technology and its potential for innovation.

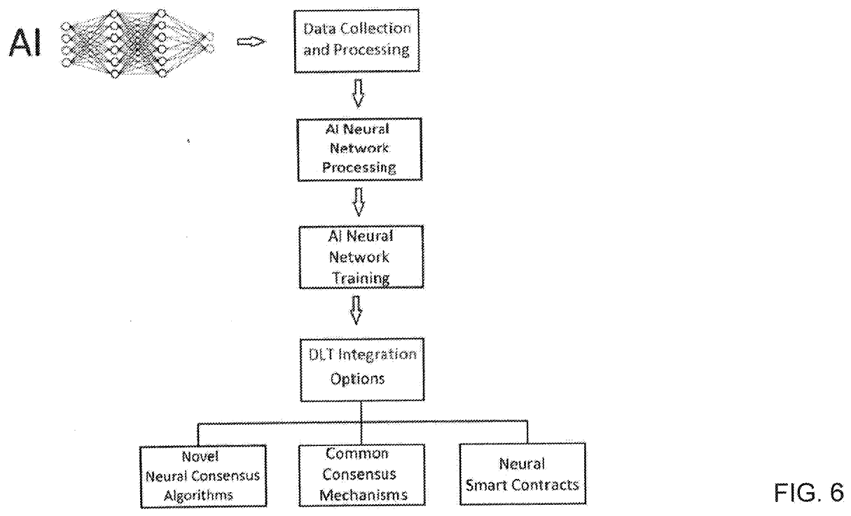

FIG. 6 shows a diagram of a simplified procedure for illustrative purposes, which visually represents certain embodiments and their sequential flow of the Neural Network Integration Procedure onto DLT, including the integration options through consensus mechanisms. At the center of the graphic, there are images resembling the letters ‘AI’ and an AI neural network, connected by arrows to four boxes arranged linearly.

The first box, titled “Data Collection and Processing,” represents the initial step of the procedure, involving the collection and processing of various data types, such as governance data, stakeholder data, and input data for the neural network.

The second box, labeled “AI Neural Network Processing,” signifies the subsequent step where the collected data undergoes processing using the AI neural network. This step encompasses tasks like data preprocessing, neural network architecture design, forward propagation, error calculation, prediction or inference, and performance evaluation.

The third box, named “AI Neural Network Training,” indicates the training phase of the AI neural network. It includes steps such as network initialization, preparation of training data, iterative training utilizing techniques like backpropagation, and performance evaluation.

The fourth box, titled “DLT Integration Options,” represents the integration of the trained AI neural network with DLT. From this box, three additional boxes branch below, each representing a specific integration option.

The first box, labeled “Novel Neural Consensus,” signifies one option for integrating the neural network onto the DLT. This option involves leveraging novel consensus mechanisms specifically designed for neural networks.

The second box, titled “Common Consensus Mechanisms,” represents another integration option. It involves utilizing well-established and commonly used consensus mechanisms within the DLT ecosystem.

The third box, named “Neural Smart Contracts,” signifies the third integration option. It involves the development and deployment of Neural Smart contracts generated by the AI neural network, referred to as Neural Smart Contracts, to facilitate the integration between the AI neural network and the DLT.

Arrows connect these boxes in a linear sequence, illustrating the flow from data collection and processing to AI neural network processing, training, and ultimately, the integration of DLT using one of the three options: novel neural consensus, common consensus mechanisms, or Neural Smart Contracts. This simplified graphic provides a high-level overview of the procedure, highlighting the key steps involved in the integration of AI neural networks with DLT and the available options for achieving consensus within the integrated system.

It is important to note that consensus mechanisms and Neural Smart Contracts serve different purposes within a DLT system and cannot be directly substituted for each other. Consensus mechanisms ensure agreement on the state of the DLT and validate transactions, while Neural Smart Contracts automate and enforce predefined rules and conditions.

While consensus mechanisms provide the underlying consensus and security for the DLT, Neural Smart Contracts enable the automation and execution of specific tasks within the DLT ecosystem. In many cases, both consensus mechanisms and Neural Smart Contracts work together to achieve the desired functionality and efficiency. The integration of AI neural networks into the DLT can benefit from utilizing either or both consensus mechanisms and

Neural Smart Contracts, depending on the specific requirements and objectives of the application.

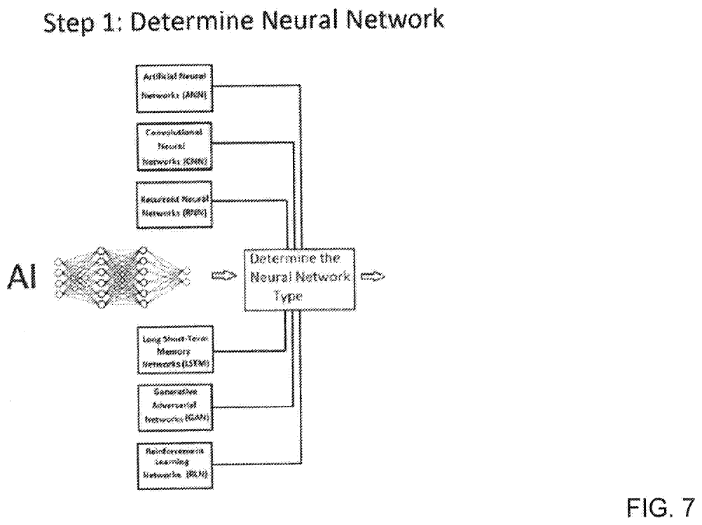

FIG. 7 is a diagram that further illustrates neural network integration procedures of certain embodiments of this invention onto DLT. FIG. 7 is directed to step 1 of these embodiments.

### Step 1: Determine Neural Network.

Step 1 of the Neural Network Integration Procedure onto DLT of these embodiments begins with the crucial task of defining the objective, which serves as a methodological prerequisite to selecting the appropriate neural network. By clearly defining the objective, the integration process can align with the specific goals and requirements of the governance system. This step ensures that the subsequent neural network selection is purpose-driven and tailored to the desired outcomes.

The flowchart representing Step 1 features an image depicting an AI neural network, symbolizing the core concept of this step. Positioned to the right of the image, an arrow points to a central box labeled “Determine the Neural Network Type.” This box serves as the focal point where the selection process takes place based on the defined objective.

Connected to the central box are subordinate boxes representing various types of neural networks, such as Artificial Neural Networks (ANN), Convolutional Neural Networks (CNN), Recurrent Neural Networks (RNN), Long Short-Term Memory Networks (LSTM), Generative Adversarial Networks (GAN), and Reinforcement Learning Networks (RLN). These boxes emphasize the diverse options and possibilities for neural network architectures that can be considered during the integration process.

The flowchart visually depicts the exploration and decision-making process involved in selecting the most suitable neural network type for the integration onto DLT. As the flow proceeds to the right, an arrow indicates the progression to the next step, which is represented on the subsequent graphic or page, continuing the integration procedure.

By incorporating the step of defining the objective as a prerequisite to selecting the appropriate neural network, the flowchart provides a comprehensive framework for guiding the integration process. It ensures that the chosen neural network aligns with the specific objectives of the governance system, enhancing the effectiveness and efficiency of the overall integration onto the DLT.

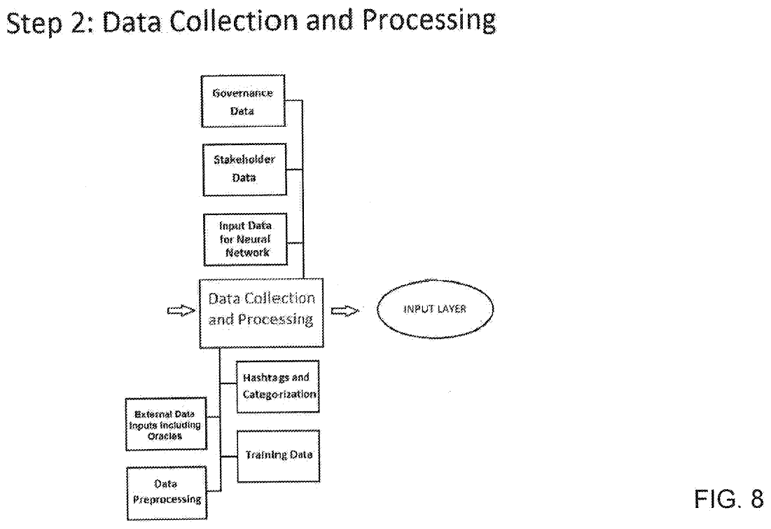

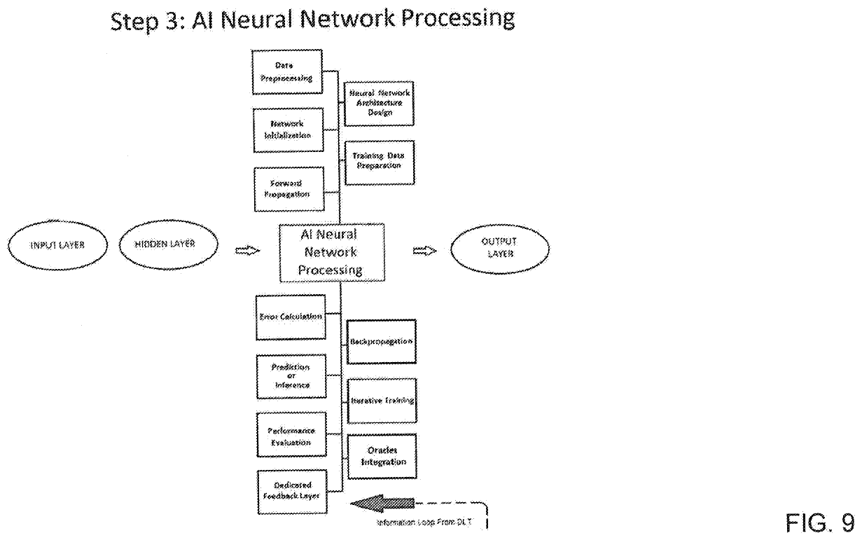

FIG. 8 is a diagram that further illustrates neural network integration procedures of certain embodiments of this invention onto DLT. FIG. 8 is directed to step 2 of these embodiments.

### Step 2: Data Collection and Processing.

Step 2 of the Neural Network Integration Procedure onto DLT is focused on Data Collection and Processing. The flowchart presents a clear visualization of this step, with a central box titled “Data Collection and Processing” representing its core. The flowchart further elaborates on this step by showcasing several subordinate boxes connected to the central box, highlighting different aspects of data collection and processing.

The flowchart visualizes how various data sources, including oracles, external data inputs, and other data types such as governance data and stakeholder data, contribute to the integration process. These subordinate boxes highlight the importance of collecting information from diverse sources, emphasizing the comprehensive nature of data collection and processing in the overall integration journey.

The flowchart proceeds sequentially through these steps, signifying the logical progression of data collection, organization, and preprocessing to prepare the input for the neural network. Each sub-step contributes to the refinement and preparation of the data required for subsequent stages of the neural network integration onto DLT.

To conclude this stage, the flowchart features an arrow pointing to a circle labeled “Input Layer,” signifying the transition to the next stage of the integration process. This visual representation effectively captures the flow and essential steps involved in data collection and processing, emphasizing the critical role of acquiring and preparing relevant data for the successful integration of the neural network onto DLT.

FIG. 9 is a diagram that further illustrates neural network integration procedures of certain embodiments of this invention onto DLT. FIG. 9 is directed to step 3 of these embodiments.

### Step 3: AI Neural Network Processing.

Step 3 of the Neural Network Integration Procedure focuses on AI Neural Network Processing. The flowchart provides a clear visualization of this step, with a central box labeled “AI Neural Network Processing” at its core. This box represents the main stage where the neural network performs its computations and processes the input data.

The integration of oracles is reflected in the flowchart by a subordinate box titled “Oracles Integration”, connected to the central box of “AI Neural Network Processing.” This box represents the specific step where oracles are incorporated into the neural network processing, facilitating the integration of external data inputs or real-time information into the decision-making process.

The remaining subordinate boxes, such as Forward Propagation, Training Data Preparation, Network Initialization, Data Preprocessing, Neural Network Architecture Design, Training Preparation, Error Calculation, Prediction or Inference, Performance Evaluation, Backpropagation, and Iterative Training, represent processes involved in neural network processing.

The flowchart concludes with an arrow pointing to a circle labeled “Output Layer,” indicating the final layer of the neural network, as it represents the ultimate outcome of the processing stage.

By incorporating the “Oracles Integration” box, the flowchart effectively represents the flow of information and operations within the AI Neural Network Processing stage, highlighting the integration of oracles and their role in incorporating external data inputs into the neural network's decision-making process.

Located at the bottom of the flowchart, a box with the description, “Dedicated Feedback Layer” highlights the AI Genesis DLT embodiment's ability to facilitate an information flowback loop within a hidden layer of the network. This loop enables the network to analyze its own performance, identify errors or inconsistencies, and adjust its internal parameters accordingly. The iterative feedback loop enhances training efficiency, improves capabilities, and contributes to the overall accuracy and reliability of the system. Placing the information loop within a hidden layer adds an extra layer of security, protecting the internal workings of the model and preventing unauthorized access or manipulation. The information flowback loop is a key feature that empowers the network to adapt, learn, and continuously improve its performance.

Additionally, a big arrow with a dotted or broken line coming up from the bottom of the flowchart with a description that says, “Information Loop from DLT” visually emphasizes the flow of information returning from the DLT to the dedicated feedback layer within the neural network. This highlights the integration of the DLT and the AI model, where the DLT provides relevant data to the neural network for pattern recognition, data analysis, predictions, or classifications, completing the information loop.

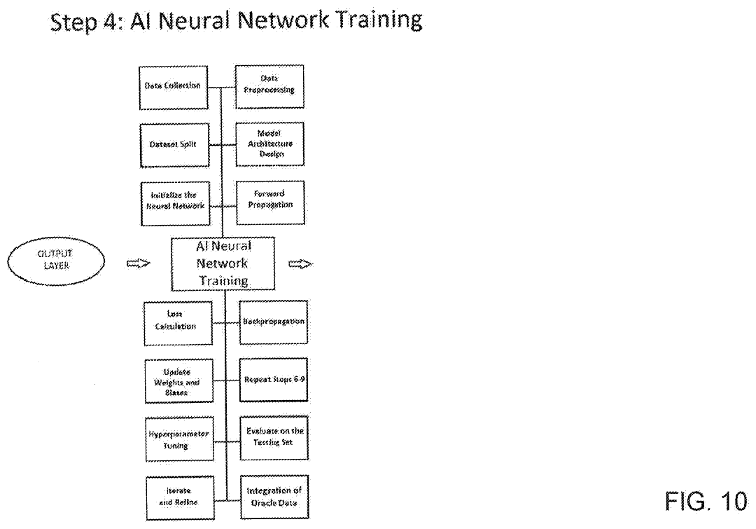

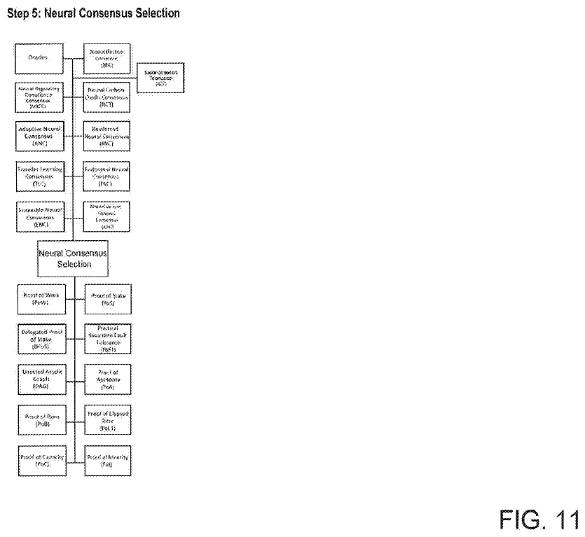

FIG. 10 is a diagram that further illustrates neural network integration procedures of certain embodiments of this invention onto DLT. FIG. 10 is directed to step 4 of these embodiments.

### Step 4: AI Neural Network Training.

In Step 4 of the Neural Network Integration Procedure, the focus shifts to AI Neural Network Training. The core of this flowchart consists of a box labeled “AI Neural Network Training,” which encompasses various interconnected subordinate boxes representing the key activities and processes involved in training the neural network. These activities include loss calculation, backpropagation, updating weights and biases, and repeating steps 6-9 of the training process.

To incorporate the option of oracles, a new subordinate box titled “Integration of Oracle Data” can be added, connected to the “AI Neural Network Training” box. This box represents the step where the neural network integrates and utilizes data obtained from oracles. The integration of oracle data enables the neural network to incorporate external information and make more informed decisions during the training process.

Additionally, the flowchart already includes relevant steps such as initializing the neural network, performing forward propagation, data collection, data preprocessing, data splitting, and model architecture design. These steps provide the necessary foundation for training the neural network.

The flowchart further emphasizes the significance of hyperparameter selection, evaluating the network on a testing set, and iteratively refining the model. These steps ensure that the trained neural network achieves optimal performance and generalization on unseen data.

The flowchart concludes with a rightward arrow indicating the continuation of the process on the next page, symbolizing the ongoing training and refinement of the neural network until the desired level of accuracy and performance is achieved.

By including the “Integration of Oracle Data” box, the flowchart incorporates the option of oracles into the AI Neural Network Training process, enabling the neural network to leverage external information and enhance its training capabilities.

FIG. 11 is a diagram that further illustrates neural network integration procedures of certain embodiments of this invention onto DLT. FIG. 11 is directed to step 5 of these embodiments.

### Step 5: Selection of Consensus Mechanism.

In Step 5 of the Neural Network Integration Procedure, the focus is on the critical stage of “Neural Consensus Selection.” This step is visualized as a central block or square in the comprehensive flowchart that represents the integration process. Above this central block, at the top of the vertical chart, “Oracles” is added as a vital component, additionally novel neural consensus mechanisms are introduced, while below the central block, the commonly used consensus mechanisms in the blockchain domain are depicted.

Oracles play a crucial role in maintaining the accuracy and relevance of regulatory consensus algorithms and other mechanisms within the integrated system. By leveraging external data sources, oracles fetch real-time information from regulatory authorities, market feeds, or other relevant sources. This continuous update ensures that the consensus mechanisms are up-to-date with the latest laws, rules, and regulations.

Consensus mechanisms play a crucial role in integrating a neural network into the AI Genesis DLT system embodiments, even in the absence of a smart contract. These mechanisms, such as Proof of Work (PoW), Proof of Stake (POS), and other consensus algorithms, serve as the foundation for achieving agreement and validating transactions within the DLT network. When it comes to integrating a neural network, these consensus mechanisms can be leveraged to validate the inputs and decisions made by the neural network.

Through the consensus process, network participants collectively agree on the validity of data inputs provided by the neural network. This consensus ensures that the neural network's outputs are accurately incorporated into the DLT, thereby contributing to the overall integrity of the system. By involving multiple nodes in the consensus process, the network can validate the analysis and decisions of the neural network, thereby enhancing transparency and trustworthiness.

While the presence of a smart contract can provide additional functionality and automation, it is not always necessary for integrating a neural network. Consensus mechanisms enable the network to validate and incorporate the outputs of the neural network into the DLT, even without the explicit use of a smart contract. This flexibility allows for the seamless integration of the neural network's capabilities within the DLT ecosystem, fostering transparency, security, and decentralized decision-making.

In addition to the commonly used consensus mechanisms, the AI Genesis DLT system embodiment incorporates several novel neural consensus algorithms. These algorithms, developed as part of the system's unique approach, include:

1. Neural Regulatory Compliance Consensus (NRCC): Focuses on maintaining system integrity by utilizing forensic compliance techniques to detect and prevent unlawful activities, ensuring regulatory compliance and enhanced security. It may rely on oracles to fetch pertinent information from regulating authorities to ensure compliance with the latest laws, rules, and regulations.

2. Adaptive Neural Consensus (ANC): Dynamically adjusts the decision-making process based on variable datasets, refining consensus over time to adapt to changing data distributions. The neural network adapts its weights and connections as new training data becomes available, allowing it to refine its consensus over time.

3. Reinforced Neural Consensus (RNC): Incorporates reinforcement learning techniques into the consensus mechanism. The neural network receives feedback and reinforcement signals based on the accuracy of its decisions, enabling continuous learning and refinement of its consensus abilities. This mechanism is well-suited for applications where the network needs to adapt to changing conditions and improve its decision-making over time.

4. Transfer Learning Consensus (TLC): Leverages transfer learning principles to generalize knowledge gained from one domain to another. The neural network is initially trained on a source dataset and then fine-tuned using variable training data from the target domain. This enables the network to achieve consensus based on the combined knowledge and experience gained from different datasets. TLC is particularly useful when there is limited labeled training data available for the target domain.

5. Federated Neural Consensus (FNC): Involves a distributed network of neural nodes, each trained on different subsets of training data. These nodes collaborate to reach a consensus by sharing their learned knowledge while maintaining data privacy. The consensus mechanism aggregates the decisions of individual nodes to produce a final outcome. FNC enables consensus in decentralized environments and is suitable when data privacy and distributed training are important considerations.

6. Ensemble Neural Consensus (ENC): Combines the outputs of multiple neural networks trained on different subsets of training data. Each network in the ensemble provides its own consensus decision, and the final consensus is determined through voting, averaging, or weighted aggregation of the individual network outputs. ENC enhances the robustness and reliability of the consensus by leveraging the collective intelligence of multiple neural networks.

7. Neural de jure Forensic Consensus (djFC): Involves training a neural network to analyze and compare legal documents, such as de facto and de jure texts, bills, treaties, constitutional amendments, etc. The neural network leverages its “Constitutional Forensic Accounting” training to identify differences, inconsistencies, or deviations from established legal frameworks. Through its consensus, the neural network provides an assessment of the compliance of these documents with constitutional principles and frameworks.

8. Neural Carbon Credit Consensus (NC3): Focuses on the monetization and transaction of carbon credits using a neural network. The neural network is trained to analyze environmental data, assess carbon footprints, and determine the eligibility and value of carbon credits. Through its consensus, the neural network facilitates the transparent and secure trading of carbon credits, contributing to environmental sustainability efforts.

9. Neural Election Consensus (NEC): The Neural Election Consensus introduces a unique approach to the consensus process in the context of elections. It leverages the power of neural networks to analyze encrypted votes, verify authenticity, and conduct advanced data analysis. This distinctive attribute enables the neural network to recognize patterns, detect anomalies, and make informed decisions, resulting in a more accurate and reliable determination of election results. By incorporating advanced AI capabilities into the consensus mechanism, Neural Election Consensus enhances the integrity, transparency, and security of the electoral process.

The integration of these neural consensus mechanisms, alongside established non-neural mechanisms such as PoW and PoS, expands the capabilities and applications of the AI Genesis DLT ecosystem embodiments. Leveraging the analytical power of neural networks, these mechanisms enable sophisticated decision-making in various fields such as legal analysis, elections, environmental conservation, and more.

Furthermore, oracles play a vital role in maintaining the accuracy and relevance of regulatory consensus algorithms and other mechanisms within the integrated system. By leveraging external data sources, oracles fetch real-time information from regulatory authorities, market feeds, or other relevant sources. This continuous update ensures that the consensus mechanisms are up-to-date with the latest laws, rules, and regulations.

During the integration process, the neural network, with its state-of-the-art training capabilities, plays a crucial role in assessing the validity and pertinence of fetched information. Through a rigorous vetting process, the neural network evaluates data reliability and quality before integrating it into the AI Genesis DLT system embodiments. This combined effort of oracles and the neural network's expertise ensures the integrity and accuracy of the integrated system, enabling it to adapt to dynamic regulatory environments and make informed decisions.

By incorporating both neural and non-neural consensus mechanisms, the AI Genesis DLT ecosystem embodiments capitalize on the unique strengths of each approach. This diversity ensures the system's flexibility, resilience, and adaptability, allowing for efficient consensus formation tailored to specific contexts and objectives.

Ultimately, this integration of a variety of neural consensus algorithms, alongside established non-neural mechanisms, empowers the AI Genesis DLT embodiments to achieve consensus across a wide range of scenarios. The result is a flexible, secure, transparent, and decentralized network that facilitates effective decision-making processes.

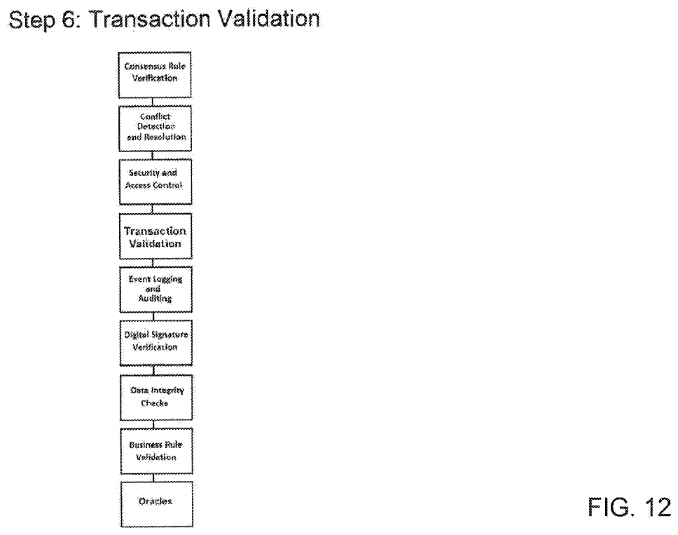

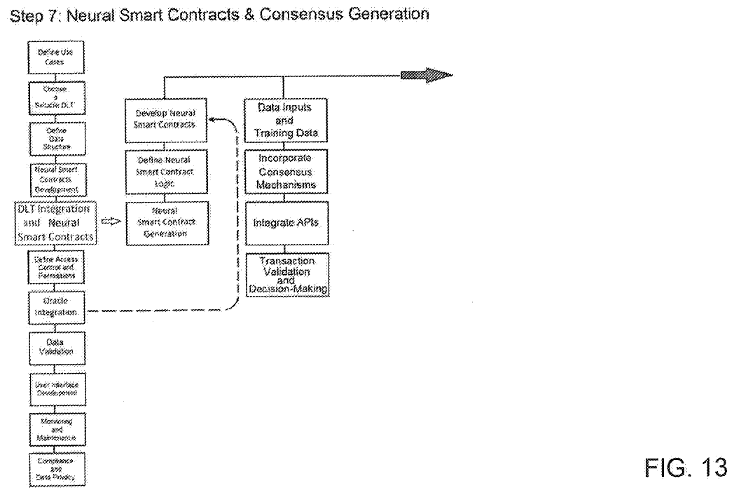

FIG. 12 is a diagram that further illustrates neural network integration procedures of certain embodiments of this invention onto DLT. FIG. 12 is directed to step 6 of these embodiments.

### Step 6: Transaction Validation.

In Step 6 of the Neural Network Integration Procedure, the focus shifts to Transaction Validation within the DLT system. The flowchart presents a series of subordinate blocks that collectively contribute to ensuring the integrity, security, and compliance of transactions processed on the DLT.

The first subordinate block is “Consensus Rule Verification.” This block represents the verification of transaction validity according to the predefined consensus rules established by the selected consensus mechanism. The consensus rules serve as a set of criteria that must be met for a transaction to be considered valid within the DLT network. By validating transactions against these rules, the DLT system ensures that only legitimate and agreed-upon transactions are accepted and processed.

The next block is “Conflict Detection and Resolution.” In this phase, potential conflicts or inconsistencies within the transaction data are identified and resolved. Conflicts may arise due to double spending, conflicting data inputs, or other issues that could compromise the accuracy and reliability of the DLT system. Through conflict detection and resolution mechanisms, such as consensus algorithms or smart contract logic, conflicts are detected and addressed to maintain the integrity of the DLT.

The “Security and Access Control” block emphasizes the importance of maintaining a secure and controlled environment for transaction processing. It involves implementing security measures, authentication protocols, and access controls to safeguard the confidentiality and integrity of the DLT system. By ensuring that only authorized participants have access to the system and that transactions are securely processed, the DLT system mitigates the risk of unauthorized activity and protects sensitive data.

“Event Logging and Auditing” plays a crucial role in maintaining an auditable trail of transaction activities. This block involves recording and logging relevant events and actions within the DLT system. Event logging facilitates traceability, accountability, and transparency, allowing for the detection of any suspicious or malicious activities. Auditing processes can then be employed to review the logged events and ensure compliance with regulatory requirements and internal policies.

The “Digital Signature Verification” block pertains to the verification of digital signatures associated with transactions. Digital signatures provide cryptographic proof of authenticity and integrity, ensuring that transactions originate from the specified senders and have not been tampered with during transit. By verifying digital signatures, the DLT system can trust the authenticity of the transactions and protect against fraudulent activities.

The “Data Integrity Checks” block involves verifying the integrity and consistency of data stored within the DLT. Through cryptographic techniques and hashing algorithms, data integrity checks ensure that the stored information remains unchanged and untampered with. By confirming the integrity of data, the DLT system maintains the accuracy and reliability of transaction records.

The last subordinate block in this stage is “Business Rule Validation.” This block represents the validation of transactions against predefined business rules and logic embedded within the smart contracts. Business rule validation ensures that transactions comply with specific rules, regulations, and constraints relevant to the use case or industry. By enforcing business rules, the DLT system guarantees compliance, accuracy, and consistency in transaction processing.

Collectively, these subordinate blocks within the Transaction Validation stage enhance the reliability, security, and compliance of the DLT system. Through consensus rule verification, conflict detection and resolution, security and access control, event logging and auditing, digital signature verification, data integrity checks, and business rule validation, the DLT system can validate and process transactions with confidence and integrity. This stage ensures that only valid and compliant transactions are accepted, promoting trust and transparency within the DLT network.

In the context of Transaction Validation, oracles can be used to fetch external data relevant to the transactions being processed. This data can include information such as market prices, weather conditions, stock market data, or any other data that is necessary to validate the transaction according to predefined business rules.

Once the external data is fetched by the oracles, it can be used in conjunction with the smart contracts to perform data integrity checks, business rule validation, and other validation processes. For example, if a smart contract involves a transaction related to the price of a commodity, the oracle can provide the current market price of that commodity, which can be compared with the transaction details to ensure its validity.

Oracles can also play a role in conflict detection and resolution. By providing access to real-time data and external events, oracles can assist in identifying and resolving conflicts within the DLT system. For instance, if two conflicting transactions are detected, an oracle can provide additional data or information to help resolve the conflict based on predefined rules or consensus mechanisms.

Furthermore, oracles can contribute to security and access control by providing authentication and verification services. They can verify digital signatures associated with transactions, ensuring the authenticity and integrity of the data being processed. By leveraging oracles for digital signature verification, the DLT system can enhance security and mitigate the risk of fraudulent or tampered transactions.

A box entitled, “Oracles” visually represents the role of oracles in the Transaction Validation step and highlights their involvement in providing external data, conflict detection and resolution, security and access control, digital signature verification, and business rule validation. Their integration adds an additional layer of trust and reliability to the DLT network.

FIG. 12 is a diagram that further illustrates neural network integration procedures of certain embodiments of this invention onto DLT. FIG. 12 is directed to step 7 of these embodiments.

### Step 7: Neural Smart Contract & Consensus Generation.

At the core of this stage 7 of the Neural Network Integration Procedure is the “DLT Integration and Neural Smart Contracts” box, representing the integration of DLT and the implementation of Smart Contracts. This central box serves as a hub for various activities, including smart contract development, defining the data structure, selecting a suitable DLT, defining use cases, establishing access control and permissions, designing the user interface, ensuring monitoring and maintenance, as well as addressing compliance and data privacy considerations.

To the right of the flowchart, an arrow points to the “Neural Smart Contract Generation” box, indicating the next step. This box signifies the generation of actual smart contracts based on the requirements and specifications identified in the previous tasks. It encapsulates the synthesis of the defined smart contract logic and the translation of business rules into executable code.

Connected to the “Neural Smart Contract Generation” box is the “Define Neural Smart Contract Logic” box, representing the definition of logical rules and conditions that govern the behavior and execution of the smart contracts. In this phase, the contract logic is carefully formulated, specifying the desired actions, data interactions, and decision-making processes within the smart contracts.

Above the “Define Neural Smart Contract Logic” box is the “Develop Neural Smart Contracts” box, highlighting the active development process of creating and implementing the smart contracts. Skilled developers utilize programming languages and tools to write the smart contract code, ensuring its functionality, security, and adherence to the predefined logic.

The flowchart continues beyond this point with a prominent arrow leading to the next stage of the Neural Network Integration Procedure. This arrow symbolizes the integration of the developed smart contracts, along with other essential components.

One such component is APIs, which encompass tasks such as connecting the smart contracts to external data sources to collect relevant information. Another crucial component is consensus mechanisms, involving the selection and integration of the chosen consensus mechanism(s) into the smart contracts. Additionally, data inputs play a significant role in defining how the smart contracts receive and process input data for validation and decision-making purposes.

The flowchart also includes a box labeled “Training Data,” which demonstrates how the integrated components, such as the neural network and consensus mechanisms, are leveraged by the smart contracts to validate transactions and make informed decisions based on processed data inputs. Transaction validation and decision-making processes are vital steps that ensure the integrity and reliability of the DLT system.

Following the completion of the Distributed Ledger Integration and Neural Smart Contracts stage, the integration process proceeds to Oracle Integration and Data Validation. This process involves the integration of oracles and the validation of data inputs within the DLT system.

To incorporate oracles into the flowchart, a box labeled “Oracle Integration” is added. This box represents the integration of external data sources, such as oracles, to provide real-time data and information to the smart contracts. Oracles play a crucial role in enhancing the reliability and accuracy of the data used by the smart contracts for validation and decision-making purposes.

Connected to the “Oracle Integration” box, a line indicates the flow of data from the oracles to the developed Neural Smart Contracts. This represents the data transfer process, where the smart contracts receive data inputs from the oracles to validate transactions and make informed decisions. The integration of oracles enables the smart contracts to access and utilize external data sources, expanding their capabilities and functionality.

The flowchart also includes a box labeled “Data Validation,” positioned below the “Oracle Integration” box. This box represents the validation of data inputs received from both the neural network and the oracles within the smart contracts. The smart contracts utilize predefined logic and consensus mechanisms to verify the integrity and accuracy of the data before executing transactions or making decisions. Data validation ensures the reliability and trustworthiness of the DLT system.

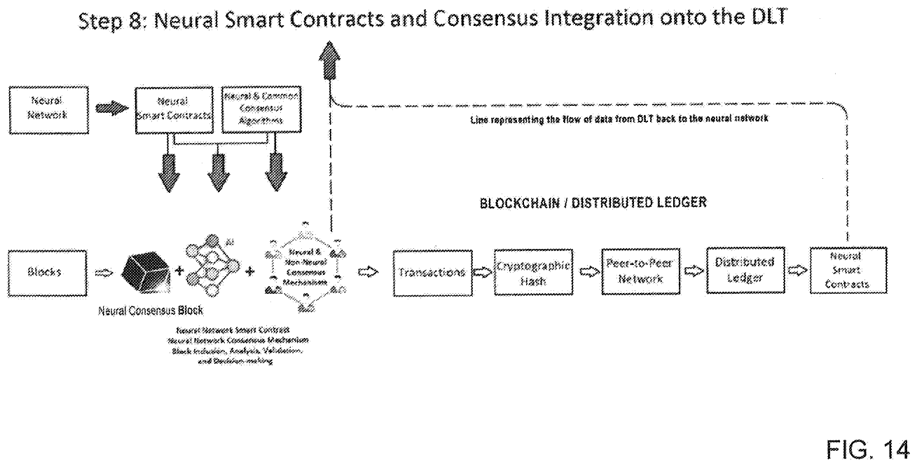

FIG. 14 is a diagram that further illustrates neural network integration procedures of certain embodiments of this invention onto DLT. FIG. 14 is directed to step 8 of these embodiments.

### Step 8: Integration Options: Neural Smart Contracts and Neural Consensus.

In Step 8 of the Neural Network Integration Procedure, the flowchart visually represents three scenarios for integrating the neural network with the DLT: Neural Smart Contracts, Neural Consensus, or a combination of both. Above the DLT, there are three boxes representing the Neural Network, Neural Smart Contracts, and Novel & Common Consensus Mechanisms. These boxes can be connected in different ways to illustrate the different integration options.

### Scenario 1: Neural Smart Contracts

In this scenario, the first box labeled “Neural Smart Contracts” represents the integration option through smart contracts. The neural network receives relevant data from the DLT, which can be facilitated through an oracle or an intermediary entity. The neural network processes and analyzes the data using its advanced learning capabilities, such as pattern recognition or data classification, to generate insights and make informed decisions. These outputs can then be utilized within the DLT ecosystem, completing the bidirectional flow of information. Furthermore, it is possible to design the integration in a way that allows feedback or information flow from the smart contracts back to the neural network. This would enable the neural network to receive updates or additional data based on the execution of the smart contracts, allowing for continuous learning and adaptation. The bidirectional flow of information between the neural network and the smart contracts enhances the overall intelligence and effectiveness of the integrated system within the DLT ecosystem.

### Scenario 2: Neural Consensus

In this scenario, the second box titled “Novel & Common Consensus Mechanisms” represents the integration option through utilizing various consensus mechanisms. Similarly, the neural network receives data from the DLT through an oracle or an intermediary entity. The neural network's outputs, such as predictions or recommendations, influence the final decision or outcome reached through consensus, creating a bidirectional flow of information. This integration enhances the system's performance, accuracy, and adaptability by leveraging the learning capabilities of the neural network in the consensus process. Additionally, the consensus mechanisms can also provide feedback or information back to the neural network, allowing it to refine its decision-making abilities based on the consensus outcomes. The bidirectional flow of information between the neural network and the consensus mechanisms facilitates a dynamic and iterative process, where the neural network continuously learns and adapts to improve the consensus outcomes. This comprehensive integration approach maximizes the intelligence and effectiveness of the system within the DLT ecosystem, promoting secure and efficient transactions while harnessing the power of the neural network.

### Scenario 3: Combined Integration

In this scenario, the flowchart showcases the combination of Neural Smart Contracts and Neural Consensus. Both options are integrated into the DLT, leveraging the power of smart contracts and consensus mechanisms, along with the decision-making capabilities of the neural network. The data flow from the DLT to the neural network is facilitated through an oracle or intermediary, enabling the neural network to process and analyze the data, generate insights, and influence the consensus process. From these integration options, three big arrows point down to the DLT, where the Neural Consensus Block+the AI symbol+the symbol for Neural & Non-Neural Consensus Mechanisms are represented. This integration combines the power of smart contracts, consensus mechanisms, and the neural network to establish a robust foundation for secure and efficient transactions and operations within the DLT ecosystem.

This flowchart is broken down from the comprehensive flowchart. It too has the same broken lines coming up from the Neural Smart Contracts box and the Neural & Non-Neural Consensus Mechanisms image and merging together and pointing upward with a big arrow. As the arrow continues, it emerges at the bottom of Step 3, “Neural Network Processing,” where the broken line points to a box entitled: “Dedicated Feedback Layer.” This indicates that the neural network receives feedback, updates, or relevant information from the integrated components and the DLT. The flowchart demonstrates the flexibility and versatility of the AI Genesis system embodiments, showcasing the different scenarios for integrating neural networks with the DLT. Each integration option offers unique advantages and capabilities, enabling advanced intelligence, secure transactions, and distributed agreement within the DLT ecosystem.

Once the neural network receives the data from the DLT, it can process and analyze the information using its advanced learning capabilities. This analysis may involve pattern recognition, data classification, or other machine learning techniques depending on the nature of the data and the objectives of the neural network. Based on the analysis, the neural network can generate new insights, update its internal state, refine its consensus abilities, or make informed decisions. These outputs can then be utilized within the DLT ecosystem, facilitating continuous learning and adaptation.

In the revised flowchart, two bidirectional arrows titled “Information Flow” are added at the top to visually represent the exchange of information between the neural network and the DLT. These arrows highlight the bidirectional nature of the integration, showcasing how data is transmitted from the DLT to the neural network for processing and analysis, and how the neural network's outputs are utilized within the DLT ecosystem. This addition further enhances the clarity of the information flow and the seamless integration between the neural network and the DLT.

The comprehensive flowchart emphasizes the potential of the integrated system for various applications and showcases its capabilities in areas such as elections, constitutional forensic accounting, and more. It illustrates how the combination of the neural network, smart contracts, and consensus mechanisms within the DLT ecosystem enables advanced intelligence, secure transactions, and distributed agreement.

The subject matter of this disclosure is now described with reference to the following additional examples. These examples are provided for the purpose of illustration only, and the subject matter is not limited to these examples, but rather encompasses all variations which are evident as a result of the teaching provided herein.

### Further Use Case Examples

Additional use case examples follow that exemplify the extensive capabilities of integrating the AI neural network onto a DLT in embodiments of this invention.

### Example: Global AI Defense and Security System (GLADES)

Global AI Defense and Security System (GLADES) represents a groundbreaking application of integrated neural networks onto the decentralized DLT. It harnesses the collective intelligence and capabilities of interconnected AI nodes in a peer-to-peer manner to enhance global defense and security while prioritizing the safe development and use of AI.

In an increasingly complex and interconnected world, the safe development and use of AI technologies have become paramount. GLADES addresses this critical aspect by leveraging integrated neural networks and the decentralized nature of DLT to create a distributed and collaborative defense framework that ensures the prevention of rogue and weaponized AI.

GLADES operates on a peer-to-peer basis, allowing AI nodes to communicate and collaborate directly, fostering transparency, accountability, and mutual validation. This decentralized architecture enables continuous monitoring and verification of AI behavior, ensuring compliance with established safety protocols and preventing the deployment of rogue or weaponized AI systems.

Within GLADES, stringent measures are implemented to vet and evaluate AI technologies before their integration into the system. The interconnected AI nodes collectively assess the safety and ethical considerations of new AI systems, employing advanced algorithms and validation procedures. This thorough evaluation process helps safeguard against the introduction of potentially harmful or malicious AI applications.

Moreover, GLADES establishes a comprehensive framework for ongoing monitoring and auditing of AI systems operating within the network. AI nodes work collaboratively to the behavior and outputs of deployed AI models, detecting any signs of unauthorized activity, deviation from ethical guidelines, or potential risks. In case of identified concerns, the system promptly triggers alerts, enabling swift response and mitigation measures.

GLADES also promotes research and development efforts focused on AI safety and security. The network fosters collaboration among experts and stakeholders to continuously enhance safety protocols, develop robust AI validation frameworks, and explore methods for detecting and mitigating emerging risks associated with AI technologies.

By integrating provisions for safe AI development and deployment, GLADES ensures that AI systems within its network adhere to ethical standards, comply with safety guidelines, and contribute to the overall security and well-being of societies worldwide. It serves as a model for responsible AI utilization, demonstrating the potential of integrated neural networks and DLT in preventing rogue and weaponized AI while enhancing global defense and security.

GLADES combines integrated neural networks with the decentralized DLT to create a peer-to-peer defense and security system. It prioritizes the safe development and use of AI by implementing robust evaluation processes, continuous monitoring, and collaborative efforts to prevent rogue and weaponized AI. GLADES sets a new standard for responsible AI utilization and showcases the transformative potential of integrated neural networks and DLT in safeguarding societies in the digital age.

### Example: Secure Elections

Integrating the AI neural network onto a distributed ledger in the context of Secure Elections, is an additional embodiment of this invention.

Integrating the AI neural network onto a distributed ledger in the context of Secure Elections revolves around the need for a trustworthy and transparent electoral system. Existing election processes often face challenges such as voter fraud, tampering with ballots, and lack of transparency, which can undermine the integrity and legitimacy of election outcomes. There is a demand for a solution that ensures secure and fair elections, where each vote is accurately counted and the process is transparent to all stakeholders.

The integration of the AI neural network onto a distributed ledger provides a promising solution for Secure Elections. By leveraging advanced algorithms and DLT technology, the integration enhances the security, transparency, and verifiability of the electoral process. The neural network can detect anomalies, identify fraudulent activities, and provide insights for fraud detection and prevention. The distributed ledger ensures the immutability and transparency of election data, allowing for decentralized access and verification. Additionally, oracles can play a role in providing external data to the AI neural network or the distributed ledger system, such as voter registration information or real-time election updates.

The system architecture for Secure Elections integration involves multiple components working together:

Voter Registration System: The system begins with a secure voter registration process, where eligible voters are registered and their information is stored in a decentralized manner on the distributed ledger.

Voting Machines: Secure voting machines are used to capture votes electronically, ensuring accuracy and integrity in the voting process. These machines are connected to the distributed ledger to record votes securely.

AI Neural Network: The AI neural network is integrated into the system to analyze voter data, detect anomalies, and identify potential fraud in real-time. It provides insights and alerts to election officials, enabling proactive measures to maintain the integrity of the elections.

DLT Integration: The distributed ledger, such as a DLT, is utilized to store and verify election data, including voter information, voting records, and election results. It ensures transparency, immutability, and decentralized access to the data, making the electoral process auditable and resistant to tampering.

Smart Contracts: Smart contracts are employed to automate various election processes, such as voter authentication, vote counting, and result declaration. They provide a trustless and transparent mechanism for executing predefined rules and ensuring the integrity of the process.

Election Monitoring and Auditing: Independent auditors and election monitors have access to the distributed ledger to verify the integrity of the electoral process. They can analyze the data and ensure that the election outcomes are accurate and trustworthy.

In a particular use case scenario, consider a local government election where voters cast their votes electronically using secure voting machines connected to the distributed ledger. The AI neural network continuously monitors the voting process, analyzing voter data in real-time to detect anomalies or fraudulent patterns. If any suspicious activity is identified, the election officials are alerted, enabling them to take immediate action. The votes are recorded on the distributed ledger, ensuring transparency and immutability. Smart contracts automate the vote counting process, ensuring accurate results. Independent auditors have access to the distributed ledger to verify the integrity of the election and provide public confidence in the outcomes.

The integration of the AI neural network onto a distributed ledger for Secure Elections offers a significant advancement in ensuring secure, transparent, and verifiable electoral processes. By leveraging advanced algorithms and DLT technology, the integration enhances fraud detection, transparency, and trust in elections. It provides a robust mechanism for maintaining the integrity of the electoral process, ensuring accurate vote counting, and enabling public confidence in the outcomes. The integration has the potential to revolutionize the democratic process, strengthening democracy and ensuring fair representation of the people's will.

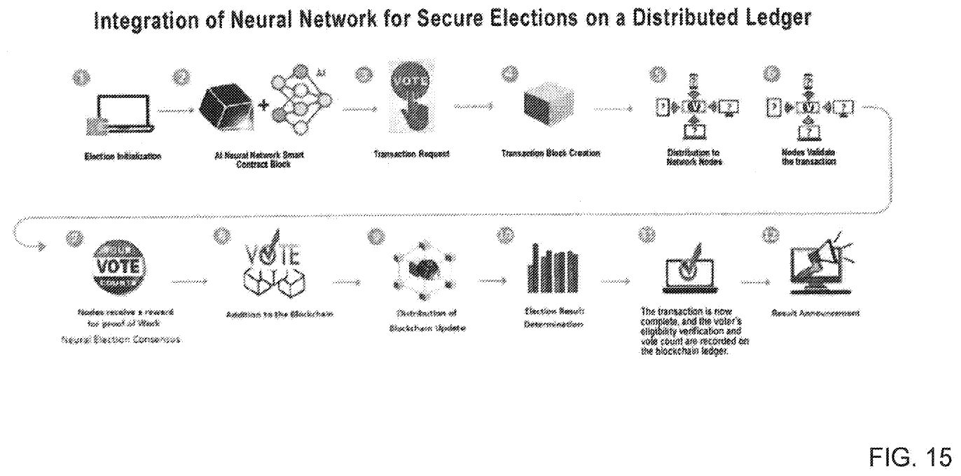

FIG. 15 is a flowchart showing integration of a neural network for secure elections on an AI Genesis blockchain embodiment. To enhance the transparency and security of elections, the utilization of the DLT, integrated with a suitable neural consensus mechanism, should provide significant improvements. An embodiment of an election flowchart includes the following steps:

1. Election Initiation: The process begins with the initiation of an election, setting the stage for the subsequent steps.

2. AI Neural Network Smart Contract Block+AI Integration: The AI Neural Network Smart Contract Block, symbolizing the integration of the neural network, plays a central role in the election process. This integration ensures the utilization of advanced AI capabilities for data analysis and decision-making.

3. Transaction Request: Participants in the election submit their transaction requests, indicating their intent to cast their votes.

4. Transaction Block Creation: The submitted transactions are grouped into blocks, creating a structured format for further processing.

5. Distribution to Network Nodes: The transaction blocks are distributed to the network nodes, ensuring decentralized storage and redundancy.

6. Nodes Validate the Transaction: The network nodes collectively validate the transactions, ensuring their accuracy and adherence to the established rules.

7. Nodes Validate the Transaction and Reach Neural Election Consensus: In this step, the network nodes collectively validate the transactions, ensuring their accuracy and adherence to the established rules. Additionally, they utilize the Neural Election Consensus mechanism to reach a consensus on the validity of the votes based on the analysis and decision-making capabilities of the integrated neural network. This consensus mechanism combines the power of consensus algorithms with the advanced intelligence of the neural network to ensure accurate and reliable determination of the election results. Vote Addition to the DLT: Validated votes are added to the DLT, creating an immutable record of the election.

8. Distribution of DLT Update: The updated DLT, now containing the validated votes, is distributed across the network nodes, ensuring consistency and accessibility.

9. Election Result Determination: With all votes securely stored on the DLT, the election results can be determined based on the accumulated votes.

10. Transaction Complete: The election transactions are considered complete, marking the end of the voting process.

11. Results Announced: The determined election results are publicly announced, providing transparency and accountability to the participants and the wider community.

By leveraging the DLT integrated with a suitable neural consensus mechanism, one can establish a more secure, transparent, and tamper-resistant election system. This innovative approach ensures the integrity of the voting process and enhances trust among participants, ultimately strengthening the democratic foundation of elections.

By incorporating the Neural Election Consensus mechanism into the Election Process over an DLT, the accuracy and reliability of the election results are significantly enhanced. Once the encrypted votes are stored in transaction blocks and distributed to network nodes for validation, the Neural Election Consensus mechanism takes center stage. Specifically, the trained neural network plays a critical role in this process by analyzing the encrypted votes, verifying their authenticity, and conducting advanced data analysis to determine the final election results.

The Neural Election Consensus mechanism harnesses the power of the neural network's pattern recognition and decision-making capabilities, ensuring a fair and trustworthy outcome. Through its ability to process and analyze complex voting data, the neural network contributes to the overall integrity and transparency of the election process. By incorporating this mechanism, the Secure Elections system establishes a robust and auditable framework for conducting secure and democratic elections.

The integration of Neural Election Consensus not only enhances the accuracy of the election results but also provides an additional layer of security. The neural network's analysis helps identify and mitigate potential threats or anomalies in the voting process, further safeguarding the integrity of the election. Moreover, the transparency and traceability inherent in DLT technology, combined with the neural network's capabilities, ensure that the election process is auditable and resistant to manipulation.

Overall, the incorporation of Neural Election Consensus into the Election Process over an DLT significantly strengthens the democratic principles underlying secure elections. It demonstrates the potential of combining advanced technologies, such as neural networks and DLT, to create a reliable and trustworthy framework for conducting elections in the digital age.

### Example: Secure And Compliant Financial Transactions

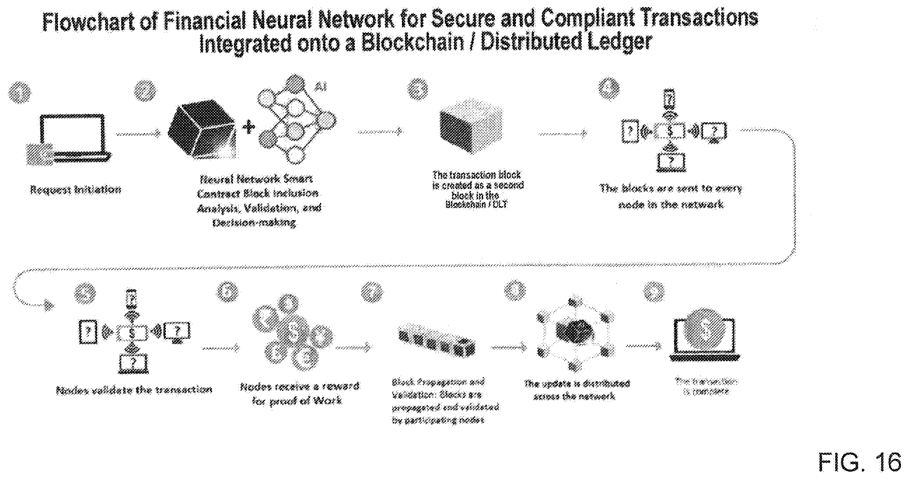

FIG. 16 is a flowchart of a digital coin financial neural network integration embodiment of this invention for secure and complaint transactions on an AI Genesis blockchain embodiment.

This Genesis DLT flowchart embodiment demonstrates the inclusion of an AI neural network, combing common and novel neural smart contracts and consensus algorithms, and subsequent neural network actions throughout the process.

Integrating the AI neural network onto a distributed ledger in the context of secure and compliant electronic financial transactions presents an innovative solution for TGcoin (TGcoin is used as an example). This integration addresses the challenges of traditional cryptocurrencies, such as scalability, transaction verification, and privacy concerns. By leveraging the DLT and its neural network capabilities, TGcoin and other financial tools can establish a secure, transparent, and efficient cryptocurrency system.

One significant advantage of integrating the AI neural network into digital coin and similar financial tools is the enhanced compliance with evolving financial rules and regulations. Financial institutions can leverage the DLT to interface with regulatory agencies and ensure continuous monitoring and updating of compliance requirements. The AI neural network, with its data processing and analysis capabilities, can stay up-to-date with the latest regulations, facilitating adherence to compliance standards in financial transactions.

Moreover, the integration of the AI neural network brings an additional layer of security to digital coin and other financial tools. Trained on financial rules and regulations, the neural network can analyze transactions in real-time, enabling advanced scrutiny. It can identify and prevent potentially illegal or non-compliant transactions promptly, safeguarding financial institutions and their clients from fraudulent or illicit activities.

The system architecture for digital coin and other financial tool integration involves key components working together seamlessly. Data collection and preprocessing prepare relevant information for analysis. The AI neural network processes the collected data, performing tasks such as fraud detection, pattern recognition, and decision-making. Integration with a distributed ledger, such as a DLT, ensures transparency, immutability, and decentralization through smart contracts. Consensus mechanisms validate transactions and create new blocks, while block propagation and validation ensure the integrity of the ledger across the network. Proof of Work and mining contribute to network security, and successful miners are rewarded with digital coin tokens. Verified transactions are recorded on the DLT, and users interact with their wallets for secure token transfer and management.

In a use case scenario, a digital coin user making an online purchase benefits from the integration of the AI neural network. Real-time transaction analysis by the neural network detects potential fraud, and the transparency of the distributed ledger ensures transaction validity. Smart contracts automate the process, verifying fund availability, executing the transaction, and updating account balances. The DLT records the transaction, providing an auditable and secure record for all network participants.

Overall, the integration of the AI neural network onto a distributed ledger for TGcoin and other financial tools offers a robust solution for secure and compliant digital transactions. By combining the power of machine learning with DLT technology, TGcoin, for example, becomes a reliable and efficient cryptocurrency system. Fraud detection, transaction verification, and decision-making capabilities are enhanced, establishing a seamless and trusted digital economy.

### Example: Cargo Handling

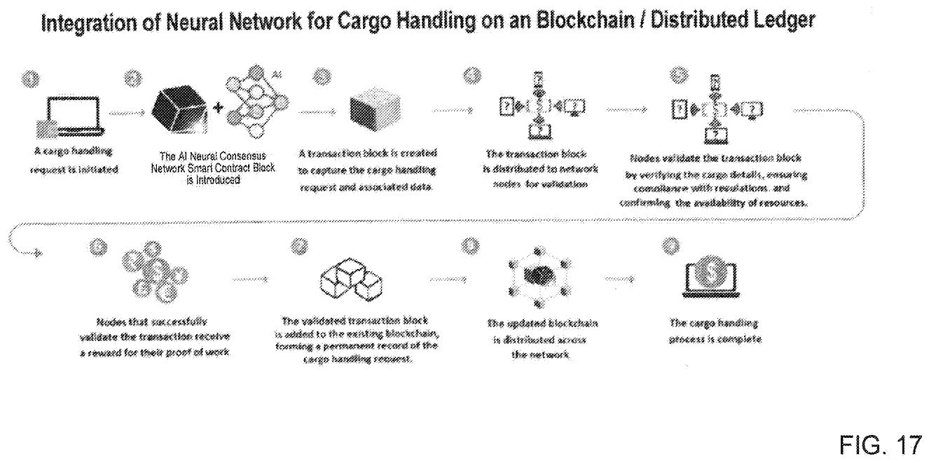

FIG. 17 is a flowchart showing an embodiment of the integration of a neural network for cargo handling on an AI (e.g., Genesis) blockchain. Cargo handling provides another useful example of a use case for the integration of the AI neural network onto a distributed ledger in the context of streamlined cargo handling.

In the cargo handling industry, there are often challenges related to inefficient processes, delays, and lack of transparency. Manual documentation, multiple intermediaries, and disparate systems can lead to errors, increased costs, and delays in cargo handling operations. There is a need for a more streamlined and secure approach to enhance efficiency, reduce delays, and improve overall transparency in cargo handling processes. By integrating the AI neural network onto a DLT, the cargo handling industry can benefit from improved operational efficiency, real-time tracking, enhanced security, and compliance with financial rules and regulations. The AI neural network, combined with the DLT, provides a secure and decentralized platform for managing cargo transactions, automating processes, ensuring data integrity, and staying in compliance with evolving financial regulations.

The integration of the AI neural network and DLT in cargo handling involves multiple components working together seamlessly. The system architecture includes the following key elements:

1. Distributed Ledger: A DLT-based distributed ledger serves as a tamper-proof and transparent platform for recording and validating cargo-related transactions, documentation, and events. It enables secure data sharing, collaboration among stakeholders, and compliance with financial rules and regulations.

2. Smart Contracts: Smart contracts are utilized to automate and enforce cargo handling agreements, terms, and conditions. These self-executing contracts eliminate the need for intermediaries, ensure compliance with financial regulations, and provide trust and transparency in cargo transactions.

3. AI Neural Network: The AI neural network is integrated into the system to provide advanced data analysis, decision-making capabilities, and compliance monitoring. It processes cargo-related data, including shipment details, logistics information, and historical patterns, to optimize routing, predict delays, detect potential issues, and prevent unlawful transactions.

4. Data Sources and Sensors: Various data sources, such as IoT sensors, tracking systems, external databases, and financial regulatory agencies, provide real-time information about cargo movements, environmental conditions, and financial regulations. These data sources feed into the AI neural network for analysis, decision-making, and compliance monitoring.

5. User Interfaces: User interfaces, such as web portals or mobile applications, enable stakeholders, including cargo handlers, shipping companies, customs authorities, financial institutions, and customers, to access relevant information, track cargo in real-time, interact with the system, and ensure compliance with financial regulations. Process Flow: The integration of the AI neural network onto the DLT for cargo handling involves the following steps set forth below.

6. Data Collection and Preprocessing: Cargo-related data, including shipment details, logistics information, environmental conditions, and financial regulatory updates, is collected from various sources and preprocessed to ensure consistency, compatibility, and compliance with financial rules and regulations.

7. AI Neural Network Processing: The preprocessed data is fed into the AI neural network, which analyzes the data using advanced algorithms and techniques. The neural network identifies patterns, predicts potential delays, detects compliance issues, and provides recommendations for optimal routing, handling strategies, and transaction validation.

8. Smart Contract Execution and Compliance Monitoring: Based on the analysis and recommendations from the neural network, smart contracts are executed on the DLT. These smart contracts automate tasks such as cargo tracking, documentation verification, customs clearance, payment settlements, and compliance monitoring with financial rules and regulations.

9. Real-Time Tracking, Compliance, and Transparency: The DLT provides real-time visibility of cargo movements, financial compliance status, and transaction history, enabling stakeholders to track shipments, monitor compliance with financial regulations, receive automated notifications, and ensure transparency in cargo handling operations.

10. Continuous Improvement and Financial Compliance Updates: The AI neural network continuously learns from the cargo handling data, feedback, and financial regulatory updates, improving its prediction accuracy, decision-making capabilities, and compliance monitoring. This iterative process enhances the overall efficiency, effectiveness, and compliance of cargo handling operations in accordance with financial rules and regulations.

Benefits: The integration of the AI neural network onto a distributed ledger for cargo handling offers several benefits, including (a) Enhanced Efficiency: Automation of processes, optimized routing, real-time tracking, and compliance monitoring reduce delays, improve resource utilization, and enhance overall operational efficiency in accordance with financial regulations; (b) Improved Transparency and Compliance: The distributed ledger provides transparency, traceability, and immutability of cargo-related data, financial transactions, and compliance status. This ensures accountability, reduces the risk of fraud or errors, and facilitates compliance with financial rules and regulations; (c) Predictive Insights and Risk Mitigation: The AI neural network analyzes historical data, real-time information, and financial regulatory updates to provide predictive insights, identify potential delays, detect compliance issues, and mitigate risks in cargo handling operations; (d) Cost Reduction: Streamlined processes, reduced delays, improved resource utilization, and compliance with financial regulations result in cost savings for cargo handling companies and financial institutions; (e) Enhanced Security and Trust: The use of a distributed ledger ensures the integrity, immutability, and security of cargo-related data, financial transactions, and compliance records. This protects against unauthorized modifications, tampering, and unlawful transactions, providing unprecedented safety on all levels; (f) Streamlined Collaboration and Interoperability: The integration of the AI neural network and DLT enables seamless collaboration, data sharing, and interoperability among stakeholders, including cargo handlers, shipping companies, customs authorities, financial institutions, supply chain management, energy, healthcare industry, regulatory agencies, and other industries where trust, transparency, and consensus are essential. This improves coordination, communication, and data exchange throughout the cargo handling ecosystem; (g) Implications: The integration of the AI neural network onto a distributed ledger in cargo handling has significant implications for the industry: Increased Efficiency, Compliance, and Customer Satisfaction: The streamlined processes, real-time tracking, predictive capabilities, and compliance with financial rules and regulations lead to faster, more reliable, and compliant cargo handling operations, resulting in improved customer satisfaction; (h) Competitive Advantage and Compliance Leadership: Companies adopting this integrated system gain a competitive edge by offering enhanced efficiency, transparency, security, and compliance in their cargo handling services. They establish themselves as leaders in compliance with financial regulations; (i) Industry Transformation and Financial Compliance Standardization: The integration of advanced technologies like neural networks and distributed ledgers has the potential to transform the cargo handling industry by introducing automation, reducing paperwork, improving operational efficiency, and standardizing financial compliance practices; (j) Collaborative Regulatory Frameworks: The integration of the AI neural network and DLT facilitates collaboration and data exchange between cargo handlers, shipping companies, customs authorities, financial institutions, and regulatory agencies. This encourages the development of collaborative regulatory frameworks that promote compliance, innovation, and interoperability.

The integration of the AI neural network onto a distributed ledger revolutionizes cargo handling processes by combining advanced data analysis capabilities, compliance monitoring, and transparency with the security, immutability, and automation provided by DLT. This innovative approach improves efficiency, enhances compliance with financial rules and regulations, enables predictive insights, and ensures secure and transparent cargo handling operations. The implications of this integration extend beyond individual cargo handling companies and financial institutions, potentially transforming the industry as a whole.

11. FIG. 17 provides a flowchart illustrating the integration of the neural network onto a distributed ledger DLT for cargo handling. In the Cargo Handling process on an DLT, the flowchart illustrates the steps involved in handling cargo requests using the power of DLT technology and AI. The integration of the AI neural network smart contract block enables analysis, validation, and decision-making based on predefined rules and AI algorithms. The transaction blocks capture the cargo handling requests, and through network consensus, they are validated, added to the DLT, and distributed across the network. This ensures transparency, immutability, and accountability in the cargo handling process, providing a reliable and auditable record for all stakeholders involved.

In the Cargo Handling process, an award can be given to nodes that successfully validate and contribute to the cargo handling transactions on the DLT. This award can be in the form of TGcoin tokens, or other similar financial tools, the native cryptocurrency of certain DLT network embodiments. Nodes that participate in the validation process and successfully complete the proof-of-work are eligible to receive TGcoin tokens as a reward for their computational efforts and contribution to the network's security and integrity. These TGcoin tokens can then be used within the ecosystem for various purposes, such as trading, accessing premium services, or even converting them to other cryptocurrencies or fiat currencies. The award incentivizes active participation in the cargo handling process and encourages the network's stability and growth.

In another example, a cargo handling company provides use case scenario where an organization can leverage the DLT for creating a company ledger and conducting company elections using the following steps and components:

### Company Ledger Creation:

(a) The cargo company initiates the process by creating a company ledger on the DLT.
(b) The ledger contains official company records such as financial statements, contracts, shipping details, and other relevant information.
(c) Each entry in the ledger is timestamped, immutable, and transparent, ensuring the integrity and trustworthiness of the data.

### Record Management:

(a) The cargo company utilizes the DLT's decentralized nature to securely store and manage its official records.
(b) Company employees with the appropriate permissions can access and update the ledger as necessary, ensuring real-time and transparent record-keeping.

### Company Elections:

(a) The cargo company can also leverage the DLT for conducting company elections, such as board member elections or voting on important decisions.
(b) Smart contracts can be created to define the rules and processes of the election, ensuring transparency, security, and accuracy.
(c) Employees or stakeholders can cast their votes through the DLT, and the votes are recorded in a tamper-proof manner, eliminating the possibility of fraud or manipulation.

By utilizing the DLT for company ledger management and elections, the cargo company benefits from enhanced data security, transparency, and efficiency. The decentralized nature of the DLT ensures that records are stored securely and cannot be tampered with. Additionally, conducting company elections on the DLT increases trust and transparency among stakeholders, as the process is verifiable and auditable. Overall, the DLT provides a robust platform for the cargo company to establish a trustworthy and efficient ledger system and carry out fair and transparent company elections.

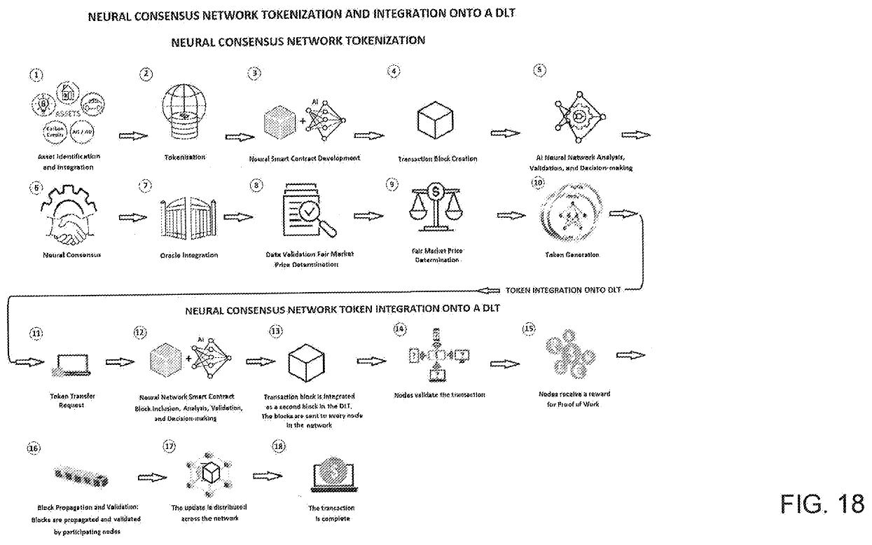

FIG. 18 Neural Consensus Network Tokenization: Neural Consensus Network Tokenization represents a revolutionary paradigm shift in the world of asset management, trading, and digital currencies. This groundbreaking technology is the embodiment of innovation, marrying the advanced capabilities of Artificial Intelligence (AI) neural networks with the transparency and security of Distributed Ledger Technologies (DLTs) and blockchains. At its core, Neural Consensus Network Tokenization empowers individuals and organizations to transform various assets, from real estate and intellectual property to carbon credits and commodities, into digital tokens that can be seamlessly traded, monetized, and accessed on decentralized platforms.

The fundamental premise of Neural Consensus Network Tokenization is to democratize access to assets, ushering in a new era of inclusivity and efficiency in financial markets. It offers a plethora of advantages that can reshape industries and provide novel opportunities for asset digitization.

First and foremost, Neural Consensus Network Tokenization streamlines the process of asset transformation into tokens, simplifying asset management while reducing administrative overhead and the risk of transactional errors. It enables fractional ownership, fragmenting high-value assets into smaller, affordable shares, thus expanding investment opportunities to a broader range of individuals.

In addition to enhanced liquidity, this innovative technology promotes financial inclusion by opening up access to a global market. Traditional financial systems are fraught with intermediaries, each adding complexity and cost to transactions. Neural Consensus Network Tokenization reduces or eliminates the need for these intermediaries, making transactions efficient and cost-effective.

The unparalleled transparency of this system ensures that transactions are recorded on the blockchain or DLT, providing a permanent, immutable record. This transparency fosters trust among participants and substantially mitigates the risk of fraud. Additionally, the integration of compliance rules directly into smart contracts ensures adherence to regulatory requirements, providing robust security against cyberattacks and fraudulent activities.

Moreover, Neural Consensus Network Tokenization inspires innovation by creating an environment ripe for the development of new financial products, services, and business models. This can lead to innovative solutions across various industries, further enriching the global economic landscape.

In essence, Neural Consensus Network Tokenization transcends the boundaries of traditional finance, offering a transformative approach to asset management, trading, and digital currencies. It is the catalyst for a future where assets are accessible to all, financial markets are efficient and transparent, and innovation knows no bounds.

The flowchart titled “Neural Consensus Network Tokenization” begins with Asset identification and integration by showcasing various types of assets, including intellectual property, real estate, carbon credits, and precious metals, that can be tokenized. Each asset type is represented within circles. The lock within the light bulb indicates the ability of the Distributed Ledger Technology (DLT) to secure intellectual property with the assistance of the Neural Consensus Network (NCN) AI.

The next step involves the actual tokenization process, represented by a globe with coins in front, indicating the conversion of these assets into tokens.

Following tokenization, the flowchart illustrates the development of a neural smart contract, denoted by a block with a plus sign, synergistically working with an AI neural network. This step is crucial for creating a robust infrastructure for asset transactions.

Next, a simple three-dimensional block signifies the creation of transaction blocks, preparing the assets for transfer.

The AI neural network analysis and decision-making step involve a neural network with a gear, indicating the AI's role in analyzing and validating transactions.

Neural consensus, represented by two shaking hands and a gear, signifies the agreement among network participants regarding the validity of the transactions.

Oracles are introduced in the flowchart as steel gates in an open position, highlighting their role in verifying and integrating external data.

Data validation is depicted by three contract symbols, with a magnifying glass indicating thorough validation before proceeding.

The balanced scale with a dollar symbol in the center signifies the determination of fair market prices for the tokenized assets.

Lastly, token generation is represented by coins with a neural network image and the word “Token,” highlighting the nature of digital tokens created in this process.

To continue onto the next flowchart titled “Neural Consensus Network Integration onto a DLT,” a line connects to the second chart interrupted inbetween with a label, “INTEGRATION ONTO DLT.”

In the second flowchart, the process begins with a “Token Transfer Request” from a computer. The request leads to the inclusion of NCN smart contract blocks and AI neural network analysis, validation, and decision-making.

The transaction then moves to the creation of transaction blocks, represented as a cube-shaped block.

Nodes validate the transaction, signified by a dollar bill surrounded by images of computers, a cell phone, and a tablet.

Multiple monetary symbols clustered together represent the transaction's continuation, with arrows pointing to the subsequent steps below.

Block propagation and validation are depicted by five linear blocks, highlighting the involvement of participating nodes in propagating and validating these blocks.

The update is distributed across the network through interconnected blocks in a hexagonal formation, emphasizing the network-wide distribution of the transaction.

Finally, the transaction is marked as complete with an image of a computer displaying a dollar sign, denoting a successful and finalized transaction.

### Code Snippet Integration Examples

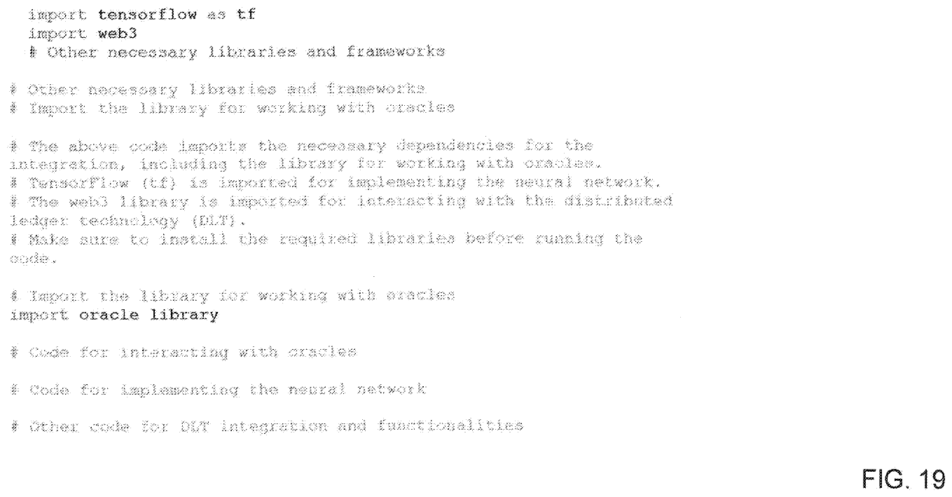

FIGS. 19-25 are snippets of code from integration processes of embodiments of this invention. The code snippets provided are simplified examples, and one may need to adapt and extend it based on the specific requirements of the application and the oracle service one is using. Implementing the fetch_data_from_oracles and process_data_into_dlt functions is necessary for fetching data from oracles and processing the verified data into the distributed system, respectively.

Thus, these snippets are provided in FIGS. 19-25 to illustrate the integration of the AI neural network onto the DLT. Below are components and code snippets that can be included in the implementation of the neural network model, taking into consideration various variables such as the neural network's architecture, programming language, consensus models, and other relevant factors.

Neural Network Architecture: The neural network's architecture is defined using the TensorFlow Keras API. The code snippet provided demonstrates the use of the tf.keras.Sequential( ) function to create a sequential model. One can customize the architecture by adding multiple layers with different configurations, such as the number of units and activation functions.

Programming Language: The code snippets are written in Python, a popular programming language for machine learning and neural network development. Python offers a wide range of libraries and frameworks, including TensorFlow, that facilitate the implementation of neural networks.

Input Dimension: The input_dim variable in the code snippet represents the number of input features or dimensions in the applicable dataset. One will need to specify the appropriate value based on the specific problem and data they are working with.

Output Classes: The num_classes variable in the code snippet determines the number of output classes or categories in the classification task. One should set this value according to the requirements of their specific problem.

Activation Functions: Activation functions play a crucial role in neural network models. In the code snippet, the ‘relu’ activation function is used in the first layer, which stands for Rectified Linear Unit. The final layer uses the ‘softmax’ activation function, which generates class probabilities for multi-class classification problems.

Customization: The provided code snippets can be customized to meet the specific requirements of the particular neural network implementation. One can add more layers, change the number of units in each layer, experiment with different activation functions, and modify the architecture as needed.

By considering these variables and utilizing the code snippets, One can create and customize a neural network model that suits the particular and specific needs and effectively address the problem that one is trying to solve.

FIG. 19 is a code snippet concerning importing dependencies. Begin by importing the necessary libraries and frameworks, such as TensorFlow for neural network implementation and libraries for DLT integration (e.g., web3.py for Ethereum-based DLT). The provided code snippet demonstrates the importation of necessary dependencies for the integration of a neural network with DLT:

1. TensorFlow (tf): TensorFlow is a popular open-source machine learning framework. By importing tensorflow as tf, the code makes the TensorFlow library available for use in the integration process. TensorFlow provides various tools and functionalities for implementing and training neural networks. Similar tools can be developed and/or used with this invention.

2. Web3: The web3 library is a Python interface for interacting with the DLT, specifically the Ethereum DLT. This library allows developers to communicate with the DLT network, access DLT data, and interact with smart contracts. It provides methods for transaction submission, contract interaction, and DLT querying.

3. Other necessary libraries and frameworks: The comment in FIG. 18 mentions that other necessary libraries and frameworks may also be imported. These dependencies could include additional packages required for specific functionalities, data processing, or integration with other systems or tools. Depending on the use case, one might need to import additional libraries or frameworks relevant to their project.

By importing these libraries and frameworks, one can ensure that the required functionalities and tools are available for implementing the integration between the neural network and the DLT.

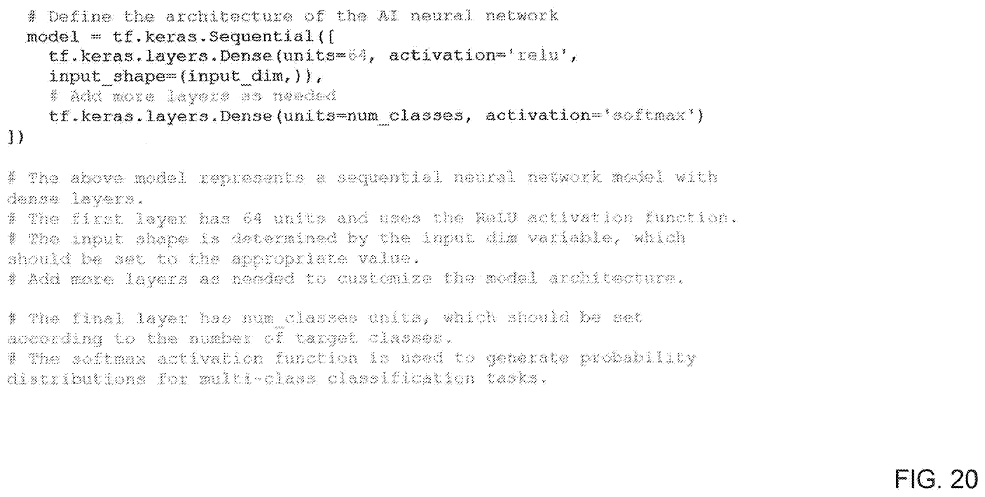

FIG. 20 is a code snippet concerning neural network architecture. The provided code snippet defines the architecture of the AI neural network model using the TensorFlow Keras API. This is what each part of the code does:

1. Model Definition: model=tf.keras.Sequential([ . . . ]): This line initializes a sequential model object using tf.keras.Sequential( ) A sequential model allows one to build a neural network by stacking layers one after another.

2. Layer Definition: tf.keras.layers.Dense(units=64, activation=‘relu’, input_shape=(input_dim,)): This line adds a dense layer to the model. The units parameter specifies the number of neurons (or units) in the layer, which in this case is set to 64. The activation parameter determines the activation function applied to the layer, with ‘relu’ (Rectified Linear Unit) being used here. The input_shape parameter defines the shape of the input data, with input_dim representing the number of input features.

3. Additional Layers: One can add more layers to the model by including additional tf.keras.layers.Dense( ) statements within the tf.keras.Sequential( ) call. These layers can have different numbers of units and activation functions, allowing one to customize the architecture of the neural network.

4. Output Layer: tf.keras.layers.Dense(units=num_classes, activation=‘softmax’): This line adds the final dense layer to the model, representing the output layer. The units parameter is set to num_classes, which should be set according to the number of target classes in the particular classification task. The activation parameter is set to ‘softmax’, which is commonly used for multi-class classification problems. It generates probability distributions over the classes, allowing one to interpret the model's output as class probabilities.

5. Comments and Explanations: The provided comments above each line of code explain what each component does. They provide guidance on how to modify and customize the architecture of the neural network based on the specific needs.

The code snippet of FIG. 20 defines a sequential neural network model for the AI neural network. It specifies the number of layers, the number of units in each layer, the activation functions, and the input and output shapes. One can adjust the architecture by adding more layers and customizing the parameters to fit the specific requirements of the particular application.

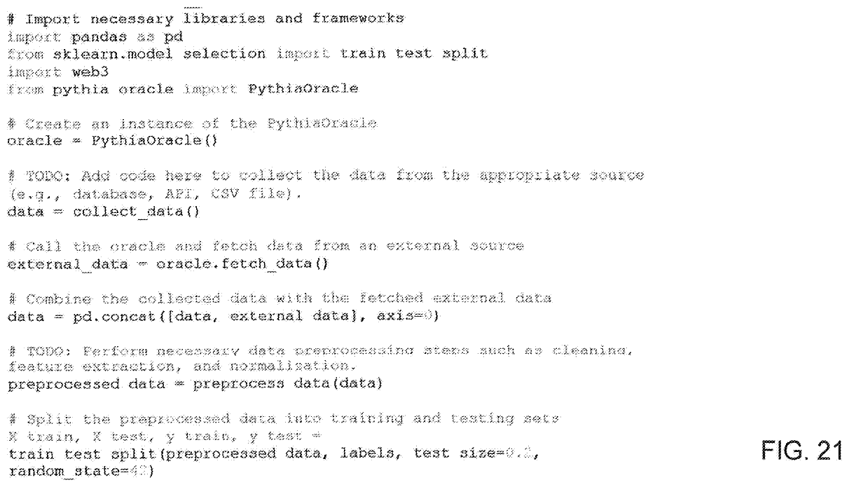

FIG. 21 is a code snippet concerning data collection and preprocessing. The provided code snippet demonstrates the process of collecting and preprocessing election data or any relevant dataset. This is what each step does:

1. Collecting and preprocessing election data: a. Data splitting: The code uses the train_test_split function from the scikit-learn library to split the input features (X) and corresponding labels (y) into training and testing sets. The test_size parameter specifies the proportion of the data to be allocated for testing, and the random_state parameter ensures reproducibility of the split.

2. Data Collection and Preprocessing: a. Data collection: The code includes a placeholder comment (TODO) indicating that one needs to add code to collect the data from the appropriate source, such as a database, API, or CSV file. This step will depend on the specific data source one is working with.

b. Data preprocessing: The code also includes a placeholder comment (TODO) indicating that one needs to add code to perform necessary data preprocessing steps. This may include cleaning the data to handle missing values or outliers, extracting relevant features, and normalizing the data to ensure consistent scales.

3. Once the data collection and preprocessing steps are completed, the data is ready for training the neural network. The code implies that one will use the preprocessed data (X_train, X_test, y_train, y_test) for training and evaluation of the neural network model.

The code snippet provides a framework for collecting and preprocessing election data or any relevant dataset. It splits the data, leaving a portion for testing, and includes placeholders for one to add code to collect the data and perform necessary preprocessing steps before training the neural network.

In this updated snippet, the existence of a collect_data( ) function is assumed that collects the data from an appropriate source (e.g., database, API, CSV file). The oracle.fetch_data( ) function is then called to fetch additional data from an external source using the oracle service.

The collected data and the fetched external data are combined using pd.concat( ) to create a single dataset. Next, the necessary data preprocessing steps, such as cleaning, feature extraction, and normalization, are performed on the combined dataset.

Finally, the preprocessed data is split into training and testing sets using the train_test_split( ) function from scikit-learn. The resulting sets are stored in X_train, X_test, y_train, and y_test, which can be used for training the neural network.

This FIG. 21 is a general example, and the specific implementation details may vary depending on the oracle service one is using and the integration requirements. One should make sure to adapt the code to the specific scenario and refer to the documentation or API reference of the chosen oracle service for the precise integration steps.

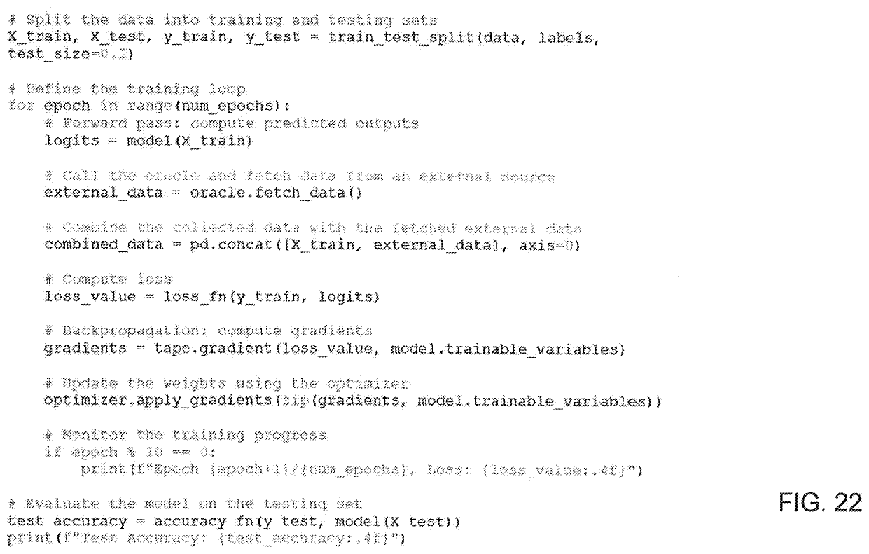

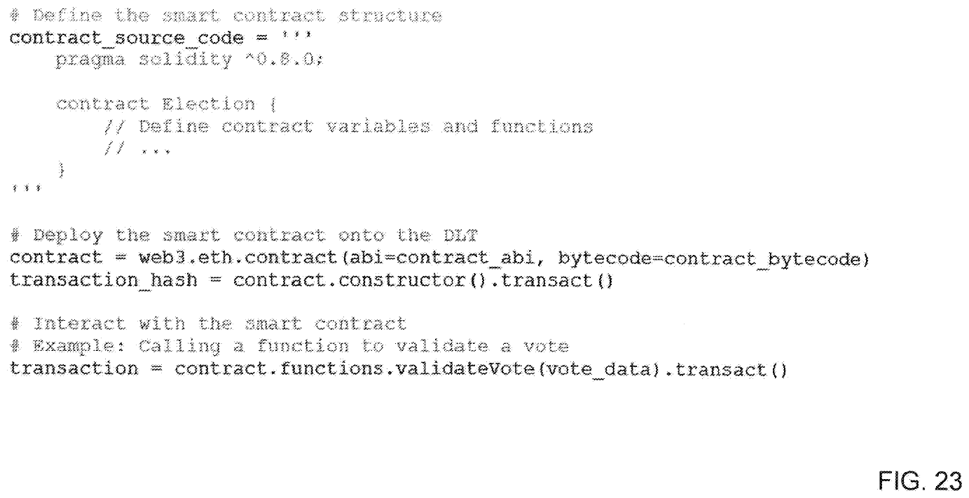

FIG. 22 is a code snippet concerning training the neural network. The code snippet outlines the training process of the AI neural network. This includes splitting the data into training and testing sets, defining the training loop, feeding the data to the network, and updating the network's weights through backpropagation. The provided code snippet performs the training and evaluation of a machine learning model using a training loop. This is what each step does:

1. Splitting the data: The code uses the train_test_split function to split the data into training and testing sets. It takes the input data data and corresponding labels labels and splits them into X_train, X_test, y_train, and y_test, where X_train and X_test represent the input features, and y_train and y_test represent the corresponding labels. The test_size parameter specifies the proportion of the data to be allocated for testing.

2. Defining the training loop: The code sets up a loop that iterates over a specified number of epochs (num_epochs). Within each epoch, the following steps are performed: a. Forward pass: The input data X_train is passed through the machine learning model model to compute the predicted outputs (logits). b. Compute loss: The predicted outputs logits and the true labels y_train are used to compute the loss value using the loss function loss_fn. c. Backpropagation: The code uses automatic differentiation (tape.gradient) to compute the gradients of the loss with respect to the model's trainable variables. d. Update the weights: The optimizer (optimizer) applies the computed gradients to update the weights of the model. e. Monitoring progress: Every 10 epochs, the code prints the current epoch number and the corresponding loss value.

3. Evaluating the model: After the training loop completes, the model is evaluated on the testing set. The code computes the accuracy of the model's predictions (model (X_test)) compared to the true labels y_test using the accuracy_fn. The test accuracy is then printed. The above snippet incorporates the oracle and is called within each training epoch to fetch data from an external source. The fetched data is then combined with the original training data using pd.concat( ) This allows the model to benefit from the additional information provided by the oracle during training.

The code snippet demonstrates a typical training process for a machine learning model. It splits the data, performs forward pass, computes the loss, applies backpropagation to update the model's weights, and monitors the training progress. The snippet evaluates the trained model on the testing set to assess its performance. Finally, by integrating the oracle into the training loop, the model can access and utilize the external data in its learning process. Note: the code will need to be adapted according to the specifics of the oracle implementation and the integration requirements

FIG. 23 is a code snippet concerning smart contract integration. The provided code snippet illustrates an example of Solidity code, a programming language commonly used for writing smart contracts on DLT platforms like Ethereum. In this snippet, a Solidity smart contract named “Election” is defined, wherein one can specify variables and functions tailored to the requirements of an election use case.

To integrate this smart contract into a distributed ledger, the next step is to deploy it onto a compatible DLT network. The deployment process involves compiling the Solidity code and utilizing tools like Truffle, Remix, or the web3.js library to deploy it onto the network. Once deployed, the contract becomes an integral part of the DLT and can be accessed and interacted with by authorized participants.

If the Neural Smart Contract(s) requires external data, the integration of oracles can be accomplished by incorporating the appropriate oracle service within the smart contract functions or during the deployment phase. This entails retrieving the required data from the oracle service and integrating it into the contract's logic.

The actual implementation of variables, functions, and oracles within the contract will depend on the specific requirements of the election system being developed. This involves defining the contract structure, specifying functions for transaction validation, and utilizing DLT-specific libraries (e.g., web3.py for Ethereum) to interact with the contract effectively.

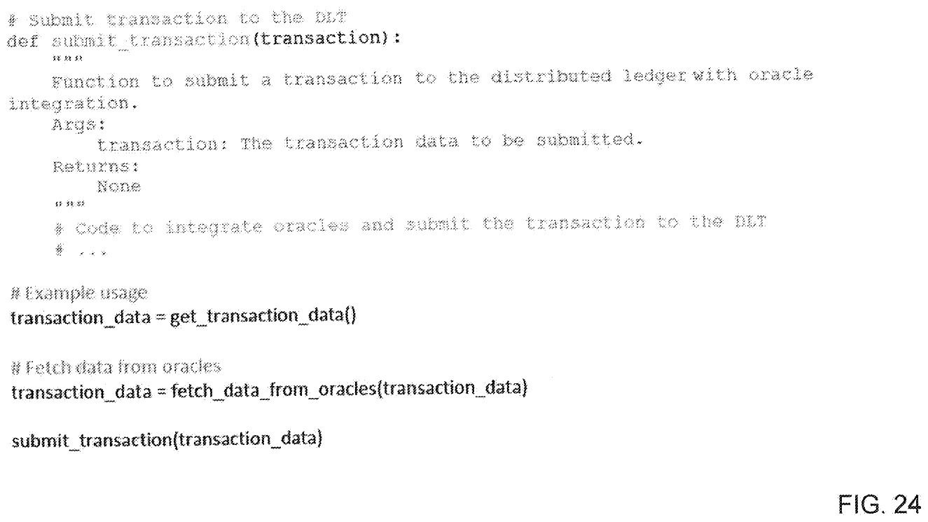

FIG. 24 is a code snippet concerning submitting a transaction to the DLT with oracle integration. To further enhance the functionality of the DLT integration, oracles are integrated into the transaction submission process. Oracles provide access to external data sources, which can be utilized to validate and enrich the submitted transactions. Below is an example of the submit_transaction function with oracle integration:

In this example, before submitting the transaction to the DLT, the function fetch_data_from_oracles is called to retrieve additional data from the oracles. This data can include external information relevant to the transaction, such as market prices, regulatory updates, or any other necessary data points. By integrating oracles, the transaction data is enriched with real-time and verified information, improving the overall quality and reliability of the transaction.

With the updated function, the transaction data is first fetched from the appropriate data sources through oracles and then passed to the submit_transaction function for submission to the DLT. This integration ensures that the transaction data is validated and augmented with up-to-date information before being recorded on the distributed ledger.

Please note that the actual implementation of the fetch_data_from_oracles function would depend on the specific oracle service being used and the required data retrieval process. The integration can be customized based on the choice of oracles and the data sources needed for the specific use case.

By incorporating oracle integration into the transaction submission process, the DLT system can benefit from a more comprehensive and reliable dataset, ensuring transaction accuracy and compliance with external factors.

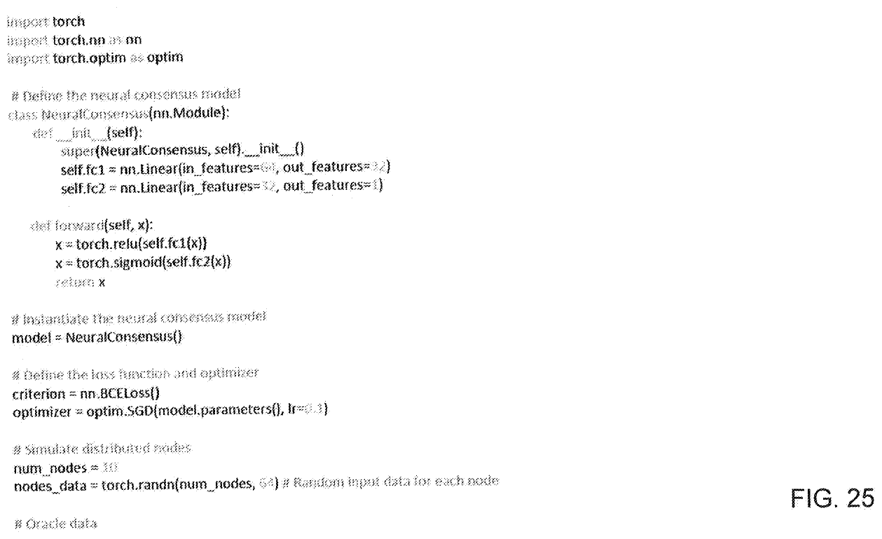

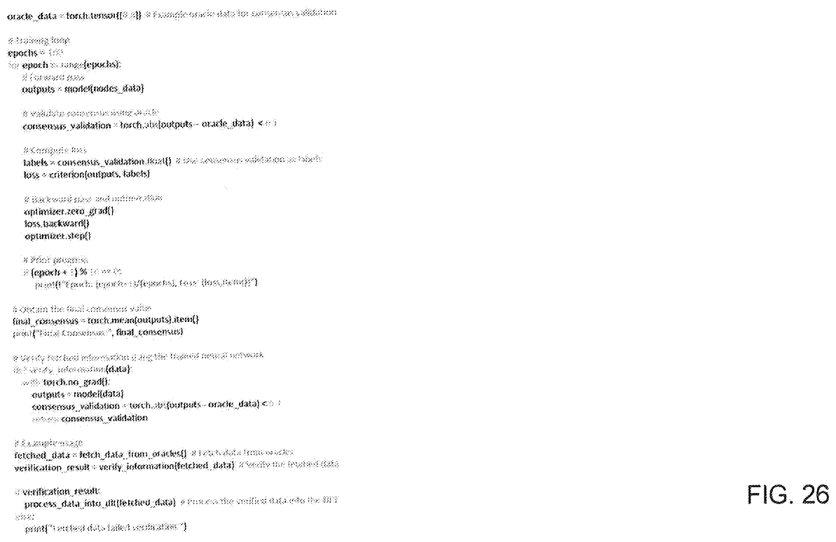

FIGS. 25 and 26 are a code snippet concerning integration of a neural consensus mechanism into a distributed system. The code snippet demonstrates the integration of a neural consensus mechanism into a distributed system, including the definition of a neural consensus model, a training loop, obtaining the final consensus value, and an option for integrating oracles into the process.

The Neural Consensus class represents the neural consensus model, which consists of two fully connected layers (fc1 and fc2) with ReLU and sigmoid activations, respectively. The forward method performs the forward pass of the model to generate consensus outputs from the input data.

The model is instantiated, and the loss function (BCELoss) and optimizer (SGD) are defined. The nodes_data variable simulates the input data for each node in the distributed system.

During the training loop, the model is trained to achieve a positive consensus. The forward pass computes the model outputs based on the input data, and the loss is calculated by comparing the model outputs with the target labels, assuming positive consensus. The optimizer updates the model parameters through backpropagation.

The training loop runs for a specified number of epochs, and the current loss is printed every 10th epoch to track the training progress.

After training, the final consensus value is obtained by taking the mean of the model outputs across all nodes. This value represents the consensus reached by the neural network model.

The code snippet also includes an option for integrating oracles into the neural consensus mechanism. The oracle_data variable represents the data obtained from an oracle for consensus validation. During each training epoch, the model outputs are compared to the oracle data to determine consensus validation. If the absolute difference between the model output and oracle data is below a certain threshold (0.1 in this case), consensus is considered valid.

The consensus validation results are used as labels for training the model instead of assuming positive consensus. This enables the model to learn from the oracle's data and improve its consensus prediction.

The updated code introduces the verify_information function, which takes the fetched data as input and verifies it using the trained neural network. The function performs a forward pass of the model on the data and calculates the consensus validation by comparing it to the oracle data. The result is returned as a boolean indicating whether the information passed the verification process.

One can use the verify_information function after fetching data from oracles. If the verification result is True, indicating that the data passed the consensus validation, one can proceed to process the data into the DLT using the process_data_into_dlt function. If the verification result is False, one can handle it accordingly, such as logging the failure or taking other appropriate actions.

It is noted that the code provided is a simplified example, and one may need to adapt and extend it based on the specific requirements and the oracle service being used. Implementing the fetch_data_from_oracles and process_data_into_dlt functions is necessary for fetching data from oracles and processing the verified data into the distributed system, respectively.

Through these examples and figures, it should be shown to a person of ordinary skill in the art that the integration of the AI neural network onto the DLT, along with the incorporation of oracles, of the embodiments of this invention, presents a groundbreaking approach that addresses complex challenges across various domains. This integration brings together the power of machine learning, the transparency of the DLT, and the real-time data inputs provided by oracles, resulting in a robust and secure system with significant implications. Throughout this demonstration, the utilization of Python snippets, smart contract examples, and data analysis code snippets further emphasizes the technological integration of the AI neural network with the DLT.

Novelty and Technical Advancements: The integration of the AI neural network, along with oracles, introduces a wide range of novel and technical advancements. It encompasses innovative algorithms, data processing techniques, consensus mechanisms, neural smart contracts, and the incorporation of real-time external data. These advancements are tailored to the specific requirements of the system, enhancing its data analysis and decision-making capabilities. Leveraging advanced neural network architectures such as Artificial Neural Networks (ANN), Long Short-Term Memory (LSTM) networks, Generative Adversarial Networks (GAN), and Reinforcement Learning Networks (RLN), along with real-time data inputs from oracles, further enhances the system's capabilities. Python code snippets showcase the technical advancements achieved through this integration, including the utilization of oracles for acquiring real-time data inputs and improving the accuracy and responsiveness of the system. Additionally, the integration introduces novel consensus algorithms, such as Adaptive Neural Consensus (ANC), Reinforced Neural Consensus (RNC), Transfer Learning Consensus (TLC), Federated Neural Consensus (FNC), Ensemble Neural Consensus (ENC), Neural de jure Forensic Consensus (djFC), Neural Carbon Credit Consensus (NC3), Neural Regulatory Forensic Consensus (NRFC), and Neural Election Consensus (NEC). These consensus algorithms, in conjunction with oracles, facilitate agreement on the validity of transactions, network state, and real-time external data within the distributed ledger, leveraging the power of neural networks. The implementation of neural smart contracts using Solidity further exemplifies the technical innovation in combining the AI neural network, oracles, and the DLT.

Business and Societal Impacts: The integration of the AI neural network, along with oracles, has far-reaching implications for businesses and society. In the context of the DLT, it ensures secure and efficient digital transactions, mitigates the risk of fraud, and promotes transparency and trust among users. Python snippets demonstrating the execution of secure transactions, fraud detection algorithms, and the integration of real-time external data highlight the practical application of the integrated system in real-world scenarios. These examples underscore the potential business benefits and societal impacts of the AI neural network integration with the DLT and oracles.

The demonstrated integration of the AI neural network onto the DLT, along with the incorporation of oracles, showcases the immense potential of combining advanced technologies to address complex challenges. The utilization of Python code snippets, smart contracts, and data analysis algorithms not only demonstrates the technological integration but also highlights the practical implementation of the integrated system. It facilitates improvements in machine learning, DLT, decentralized systems, and the utilization of real-time external data provided by oracles. The implications of this integration, with the inclusion of oracles, extend beyond specific use cases, such as TGcoin and elections, paving the way for secure and efficient systems in various domains, including finance, healthcare, supply chain, and more. This integration, incorporating oracles, opens up new possibilities for innovation, transparency, and trust in the digital age.

### Overview of Particular Embodiments of the NCN Architecture

The Neural Consensus Network architecture described in embodiments of this invention comprises the Neural Consensus Network (NCN) and the Neural Consensus Algorithms (types of consensus mechanisms).

The NCN is the broader architecture or system that incorporates Neural Consensus Algorithms. FIG. 5 is a snapshot of the preferred embodiments of the Neural Consensus Network architecture and demonstrates the broader architecture and encompasses the entire framework of nodes (computational units) that are interconnected and work together to achieve consensus. This network includes various components such as neural networks, oracles, smart contracts, data sources, and more. The Neural Consensus Network integrates these elements and orchestrates their interactions to achieve consensus, validate transactions, or perform other functions.

Neural Consensus Algorithms are the mathematical or computational procedures used within a Neural Consensus Network to achieve agreement or consensus among nodes in a distributed network. These algorithms define how information is processed, weighted, and combined by individual nodes or participants in the network. Neural Consensus Algorithms can be considered the core mathematical models that enable consensus to be reached within the network.

The NCN in these embodiments is the larger infrastructure that incorporates these algorithms along with other components to create a distributed, intelligent, and consensus-driven system, which is taught herein. See, e.g., FIG. 11. Both the NCN and the algorithms are integral to the operation of a blockchain, distributed ledger, or similar technology that relies on consensus mechanisms.

The Neural Consensus Network architecture in these embodiments not only incorporates various neural networks but also synergistically enhances their functionality. By integrating these neural networks into the consensus architecture, their capabilities experience substantial growth. This collaborative approach amplifies the effectiveness of individual neural networks, resulting in a significant boost in their performance and potential applications. It is the Neural Consensus Network architecture that enhances the other neural networks by enhancing their performance, while being integrated onto a distributed ledger.

### Certain Particularly Preferred Embodiments of Methods

A preferred embodiment of a method of this invention is a method for integrating a plurality of neural networks, neural smart contracts, oracles, and neural consensus algorithms onto a DLT distributed ledger. This preferred method comprises (a) storing and verifying transactions in a decentralized and immutable manner on the DLT distributed ledger; (b) performing data analysis tasks and sharing information with the plurality of neural networks by the DLT distributed ledger, which neural networks are operatively connected to the DLT distributed ledger; (c) enabling the neural smart contracts, implemented within the DLT distributed ledger, to automatically execute and enforce predefined functions and decision-making processes; and (d) facilitating agreement on the validity of transactions, network state, and oracle data among the participants in the DLT distributed ledger, using neural consensus algorithms (with or without common consensus algorithms also) implemented within the DLT distributed ledger.

This method may also comprise providing external data inputs to the plurality of neural networks by integrated oracles, to enable real-time information integration and to enhance the accuracy and responsiveness of the method. This integration of oracles is an optional method and may not be applicable in all scenarios. Use cases such as elections, where outside interference should be minimized, may not include the integration of external components like oracles.

In certain scenarios, consensus algorithms may be the preferred method to integrate the neural network, providing a robust and secure mechanism for decision-making and maintaining the integrity of the system.

In this method, the plurality of neural networks in some embodiments comprises a first neural network for data preprocessing, a second neural network for pattern recognition, and a third neural network for decision-making. In some embodiments the DLT distributed ledger facilitates secure and transparent storage of neural network models, training data, analysis results, neural smart contracts, and oracle data, allowing for decentralized access and update mechanisms.

In certain embodiments of this method, the integration of the plurality of neural networks, neural smart contracts, oracles, and neural consensus algorithms onto the DLT distributed ledger enables collaborative learning, information sharing, automated governance processes, and real-time integration of external data among the participants, enhancing the overall accuracy, efficiency, and decision-making speed.

In certain embodiments of this method that are applied to elections, the transactions are voting that is analyzed for fraud detection and prevention and real-time election monitoring. In other embodiments of this method that are applied to token creation, the consensus mechanisms determine the value and representation of tokens associated with various assets which are digital representations that can be traded on a blockchain or distributed ledger. A steering system is an optional additional to token creation and it permits token holders and stakeholders to have the option to participate in decision-making processes and influence various aspects of the network through mechanisms like voting and smart contracts.

In other embodiments of this method that are applied to financial transactions, the transactions are financial transactions that are analyzed for risk assessment and credit scoring, fraud detection and prevention, and personalized investment recommendations. In other embodiments of this method that are applied to carbon credits, the transactions are carbon credits that are analyzed for carbon footprint calculations, carbon credit trading optimization, and emission reduction planning. In other embodiments of this method that are applied to regulatory forensic accounting, the transactions are accounting transactions that are analyzed for regulatory compliance monitoring, forensic data analysis, and risk management and auditing. In other embodiments of this method that are applied to cargo handling, the transactions are cargo handling requests that are analyzed for cargo details, ensuring compliance with regulations and confirming the availability of resources.

In another preferred embodiment of a method of this invention, the method is a method for integrating a plurality of neural networks, neural smart contracts, oracles, and neural consensus algorithms onto a DLT distributed ledger, enabling the DLT distributed ledger to be a decentralized DLT distributed ledger framework that comprises a network of AI nodes that grows and evolves over time, promoting decentralization and collaboration among participants. The method comprises (a) receiving data from multiple sources, including oracles, and preprocessing the data using a first neural network; (b) transmitting the preprocessed data to a second neural network for pattern recognition and generating insights; (c) storing the generated insights and analysis results, including oracle data, on the DLT distributed ledger; (d) accessing the stored insights and oracle data by a third neural network for decision-making; (e) updating the DLT distributed ledger with the decision outcomes and incorporating real-time oracle data; (f) repeating steps (a) to (e) iteratively to refine the neural network's performance and to incorporate the latest oracle information; (g) executing predefined functions and decision-making processes using neural smart contracts within the DLT distributed ledger; and (h) applying neural consensus algorithms, including both novel and common algorithms, to reach agreement on the validity of transactions, network state, and oracle data within the DLT distributed ledger. In some embodiments, the DLT distributed ledger ensures the integrity, security, and transparency of the data, insights, decision outcomes, neural smart contracts, oracle data, and consensus-related information exchanged.

In certain scenarios, consensus algorithms may be the preferred method for integrating the neural network of this particular preferred embodiment, providing a secure and trusted framework for decision-making and maintaining the integrity of the process. Consensus algorithms offer a flexible option for integrating the neural network, ensuring consensus among participants and supporting secure decision-making processes.

In certain embodiments of this method that are applied to elections, the transactions are voting that is analyzed for fraud detection and prevention and real-time election monitoring. In other embodiments of this method that are applied to token creation, the consensus mechanisms determine the value and representation of tokens associated with various assets which are digital representations that can be traded on a blockchain or distributed ledger. A steering system is an optional additional to token creation and it permits token holders and stakeholders to have the option to participate in decision-making processes and influence various aspects of the network through mechanisms like voting and smart contracts.

In other embodiments of this method that are applied to financial transactions, the transactions are financial transactions that are analyzed for risk assessment and credit scoring, fraud detection and prevention, and personalized investment recommendations. In other embodiments of this method that are applied to carbon credits, the transactions are carbon credits that are analyzed for carbon footprint calculations, carbon credit trading optimization, and emission reduction planning. In other embodiments of this method that are applied to regulatory forensic accounting, the transactions are accounting transactions that are analyzed for regulatory compliance monitoring, forensic data analysis, and risk management and auditing. In other embodiments of this method that are applied to cargo handling, the transactions are cargo handling requests that are analyzed for cargo details, ensuring compliance with regulations and confirming the availability of resources.

Still another preferred method of this invention is a method of integrating an AI neural network onto a distributed ledger. This method uses a data collection module, an AI neural network module, a neural consensus module, and an integration and neural smart contracts DLT module, in order to analyze and process data, as well as having other possible functions and using other possible modules and components. The method comprises (a) collecting and preprocessing the data using the data collection module; (b) processing the preprocessed data from the data collection module with the AI neural network module; (c) training the AI neural network using the processed data with the AI neural network module; (d) selecting a consensus mechanism to apply to the processed data using the neural consensus module and to define and validate the transaction; and (e) integrating the AI neural network onto the distributed ledger using an integration and neural smart contracts DLT module in order to analyze the results of the processed data and the transaction using neural smart contracts.

### Certain Particularly Preferred Embodiments of an Apparatus and System

A preferred embodiment of an apparatus (e.g., an apparatus/components used in a system) is an integrated DLT distributed ledger integrated with a plurality of neural networks, neural smart contracts, oracles, and neural consensus algorithms. This integrated DLT distributed ledger comprises (a) a storage module and a verification module for storing and verifying transactions in a decentralized and immutable manner on the integrated DLT distributed ledger; (b) a connection module for connecting the integrated DLT ledger to the plurality of neural networks for performing data analysis tasks and sharing information with the plurality of neural networks; (c) a neural smart contracts module for enabling the neural smart contracts to automatically execute and enforce predefined functions and decision-making processes; and (d) a neural consensus algorithm module for facilitating agreement on the validity of transactions, network state, and oracle data among the participants in the integrated DLT distributed ledger.

This integrated DLT distributed ledger in certain embodiments may also comprise an oracle module for providing external data inputs to the plurality of neural networks, to enable real-time information integration and to enhance accuracy and responsiveness. The integration of an oracle module is an optional component or feature and it may not be applicable in all scenarios. Use cases such as elections, where outside interference should be minimized, may not include the integration of external components like oracles.

In certain scenarios, consensus algorithms may be preferred to integrate the neural network, providing a robust and secure mechanism for decision-making and maintaining the integrity of the system.

This integrated DLT distribution ledger in certain embodiments may use a plurality of neural networks that comprise a first neural network for data preprocessing, a second neural network for pattern recognition, and a third neural network for decision-making.

This integrated DLT distribution ledger in certain embodiments may facilitate secure and transparent storage of neural network models, training data, analysis results, neural smart contracts, and oracle data, allowing for decentralized access and update mechanisms.

This integrated DLT distribution ledger in certain embodiments may use the integration of the plurality of neural networks, neural smart contracts, oracles, and neural consensus algorithms onto the DLT distributed ledger to enable collaborative learning, information sharing, automated governance processes, and real-time integration of external data among the participants, enhancing the overall accuracy, efficiency, and decision-making speed.

An additional preferred embodiment of this invention is described as an AI neural network integrated with a distributed ledger to make an integrated network/ledger to process data. This integrated network/ledger comprises (a) a data collection module to collect and preprocess the data; (b) an AI neural network module to process the preprocessed data and train itself using the processed data; (c) a neural consensus module to select and apply a neural consensus mechanism to the processed data and to define and validate a transaction; and (d) an integration and neural smart contracts DLT module for integrating the AI neural network onto the distributed ledger so that the distributed ledger can analyze the processed data and the transaction using neural smart contracts.

### Particular Applications to Computer Devices

In certain embodiments, the interconnected AI computer systems are formed from a network of AI nodes, with secondary nodes representing various devices such as computers, cell phones, and IoT devices. In this network, AI nodes serve as the primary intelligent units, while secondary nodes act as the endpoints or access points through which users interact with the AI system. This interconnected system facilitates seamless communication, data sharing, and collaborative processing across a wide range of devices, enabling efficient and intelligent interactions between users and the AI infrastructure.

The functions and features of the methods and devices of this invention described herein may be organized in the form of one or more modules that contain the hardware and/or the capabilities (e.g., instructions) to perform the steps and functions of the methods and devices described herein. These modules can be combined together or separated into different parts and thus when a singular module is described herein, it can be implemented in multiple modules, and the work of multiple modules described herein can be combined and implemented in less or only one module.

A system, a component, and a device applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams and flowcharts of methods, apparatus (systems) and computer program products according to embodiments of the invention. The steps disclosed may be combined together in certain embodiments, or split into separate steps and implemented by separate components. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A method for integrating a plurality of neural networks, neural smart contracts, and neural consensus algorithms onto a distributed ledger, the method comprising:
a. storing and verifying transactions in a decentralized and immutable manner on the distributed ledger;
b. performing data analysis tasks and sharing information with the plurality of neural networks by the distributed ledger, which neural networks are operatively connected to the distributed ledger;
c. enabling the neural smart contracts, implemented within the distributed ledger, to automatically execute and enforce predefined functions and decision-making processes; and
d. facilitating agreement on the validity of transactions, and network state, among the participants in the distributed ledger, using neural consensus algorithms implemented within the distributed ledger.

2. The method of claim 1, further comprising providing external data inputs to the plurality of neural networks by integrated oracles, to enable real-time information integration and to enhance the accuracy and responsiveness of the method.

3. The method of claim 1, wherein the plurality of neural networks comprises a first neural network for data preprocessing, a second neural network for pattern recognition, and a third neural network for decision-making.

4. The method of claim 1, wherein the distributed ledger facilitates secure and transparent storage of neural network models, training data, analysis results, and neural smart contracts, allowing for decentralized access and update mechanisms.

5. The method of claim 1, wherein the integration of the plurality of neural networks, neural smart contracts, and neural consensus algorithms onto the distributed ledger enables collaborative learning, information sharing, automated governance processes, and real-time integration of external data among the participants, enhancing the overall accuracy, efficiency, and decision-making speed.

6. The method of claim 1 applied to elections, wherein the transactions are voting that is analyzed for fraud detection and prevention and real-time election monitoring.

7. The method of claim 1 applied to token creation, where consensus mechanisms determine the value and representation of tokens associated with various assets which are digital representations that can be traded on a blockchain or distributed ledger.

8. The method of claim 1 applied to financial transactions, wherein the transactions are financial transactions that are analyzed for risk assessment and credit scoring, fraud detection and prevention, and personalized investment recommendations.

9. The method of claim 1 applied to carbon credits, wherein the transactions are carbon credits that are analyzed for carbon footprint calculations, carbon credit trading optimization, and emission reduction planning.

10. The method of claim 1 applied to regulatory forensic accounting, wherein the transactions are accounting transactions that are analyzed for regulatory compliance monitoring, forensic data analysis, and risk management and auditing.

11. The method of claim 1 applied to cargo handling, wherein the transactions are cargo handling requests that are analyzed for cargo details, ensuring compliance with regulations and confirming the availability of resources.

12. An integrated distributed ledger that is integrated with a plurality of neural networks, neural smart contracts, and neural consensus algorithms, the integrated distributed ledger comprising:
a. a storage module and a verification module for storing and verifying transactions in a decentralized and immutable manner on the integrated distributed ledger;
b. a connection module for connecting the integrated distributed ledger to the plurality of neural networks for performing data analysis tasks and sharing information with the plurality of neural networks;
c. a neural smart contracts module for enabling the neural smart contracts to automatically execute and enforce predefined functions and decision-making processes; and
d. a neural consensus algorithm module for facilitating agreement on the validity of transactions, and network state, among the participants in the integrated distributed ledger.

13. The integrated distributed ledger of claim 12, further comprising an oracle module for providing external data inputs to the plurality of neural networks, to enable real-time information integration and to enhance accuracy and responsiveness.

14. The integrated distribution ledger of claim 12, wherein the plurality of neural networks comprises a first neural network for data preprocessing, a second neural network for pattern recognition, and a third neural network for decision-making.

15. The integrated distribution ledger of claim 12, wherein the integrated distributed ledger using the storage module further facilitates secure and transparent storage of neural network models, training data, analysis results, neural smart contracts, and oracle data, allowing for decentralized access and update mechanisms.

16. The integrated distribution ledger of claim 12, wherein the integration of the plurality of neural networks, neural smart contracts, oracles, and neural consensus algorithms onto the distributed ledger enables collaborative learning, information sharing, automated governance processes, and real-time integration of external data among the participants, enhancing the overall accuracy, efficiency, and decision-making speed.

17. A method for integrating a plurality of neural networks, neural smart contracts, oracles, and neural consensus algorithms onto a distributed ledger, enabling the distributed ledger to be a decentralized distributed ledger framework that comprises a network of AI nodes that grows and evolves over time, promoting decentralization and collaboration among participants, the method comprising:
a. receiving data from multiple sources using the distributed ledger, including oracles, and preprocessing the data using a first neural network;
b. transmitting the preprocessed data to a second neural network for pattern recognition and generating insights;
c. storing the generated insights and analysis results, including oracle data, on the distributed ledger;
d. accessing the stored insights and oracle data by a third neural network for decision-making;
e. updating the distributed ledger with the decision outcomes and incorporating real-time oracle data;
f. repeating steps a) to e) iteratively to refine the neural network's performance and to incorporate the latest oracle information;
g. executing predefined functions and decision-making processes using neural smart contracts within the distributed ledger; and
h. applying neural consensus algorithms, including both novel and common algorithms, to reach agreement on the validity of transactions, network state, and oracle data within the distributed ledger.

18. The method of claim 17, wherein the distributed ledger ensures the integrity, security, and transparency of the data, insights, decision outcomes, neural smart contracts, oracle data, and consensus-related information exchanged.

19. The method of claim 17 applied to elections, wherein the transactions are voting that is analyzed for fraud detection and prevention and real-time election monitoring.

20. The method of claim 17 applied to financial transactions, wherein the transactions are financial transactions that are analyzed for risk assessment and credit scoring, fraud detection and prevention, and personalized investment recommendations.

21. The method of claim 17 applied to tokenization, wherein the transactions involve the creation of digital representations to enable asset monetization and trading on distributed ledger technologies and blockchains.

22. The method of claim 17 applied to carbon credits, wherein the transactions are carbon credits that are analyzed for carbon footprint calculations, carbon credit trading optimization, and emission reduction planning.

23. The method of claim 17 applied to regulatory forensic accounting, wherein the transactions are accounting transactions that are analyzed for regulatory compliance monitoring, forensic data analysis, and risk management and auditing.

24. The method of claim 17 applied to cargo handling, wherein the transactions are cargo handling requests that are analyzed for cargo details, ensuring compliance with regulations and confirming the availability of resources.

25. A method of integrating an AI neural network onto a distributed ledger using a data collection module, an AI neural network module, a neural consensus module, and an integration and neural smart contracts DLT module, in order to analyze and process data, the method comprising:
a. collecting and preprocessing the data using the data collection module;
b. processing the preprocessed data from the data collection module with the AI neural network module;
c. training the AI neural network using the processed data with the AI neural network module;
d. selecting a consensus mechanism to apply to the processed data using the neural consensus module and to define and validate the transaction; and
e. integrating the AI neural network onto the distributed ledger using an integration and neural smart contracts DLT module in order to analyze the results of the processed data and the transaction using neural smart contracts.

26. An AI neural network integrated with a distributed ledger to make an integrated network/ledger to process data, the integrated network/ledger comprising:
a. a data collection module to collect and preprocess the data;
b. an AI neural network module to process the preprocessed data and train itself using the processed data;
c. a neural consensus module to select and apply a neural consensus mechanism to the processed data and to define and validate a transaction; and
d. an integration and neural smart contracts DLT module for integrating the AI neural network onto the distributed ledger so that the distributed ledger can analyze the processed data and the transaction using neural smart contracts.
